(19) United States
(12) Patent Application Publication
(10) Pub. No.: US 2017/0147231 A1
(43) Pub. Date: May 25, 2017

(54) STORAGE DEVICE AND OPERATING METHOD OF STORAGE DEVICE

(71) Applicant: SAMSUNG ELECTRONICS CO., LTD., SUWON-SI (KR)

(72) Inventor: MYUNG-JUNE JUNG, SUWON-SI (KR)

(21) Appl. No.: 15/353,783

(22) Filed: Nov. 17, 2016

(30) Foreign Application Priority Data
Nov. 23, 2015 (KR) 10-2015-0164258

(51) Int. Cl. G06F 3/06; G06F 7/26

(52) U.S. Cl. CPC G06F 3/0611; G06F 3/0647; G06F 3/067; G06F 7/26

(57) ABSTRACT

A storage device includes an interface circuit configured to communicate with an external device, nonvolatile memory devices forming a plurality of partitions, and a processing circuit configured to receive a write request, a key, and a value from the interface circuit, to generate a partition identifier and a sort identifier from the received key, to select one of the partitions using the partition identifier, and to sort indexes of accumulated keys corresponding to the selected partition using sort identifiers included in the indexes.

### CROSS-REFERENCE TO RELATED APPLICATIONS

A claim of priority under 35 U.S.C. §119 is made to Korean Patent Application No. 10-2015-0164258, filed Nov. 23, 2015, in the Korean Intellectual Property Office, the entire contents of which are hereby incorporated by reference.

### BACKGROUND

The inventive concepts disclosed herein relate an electronic device, and in particular, relate to a storage device and an operating method of the storage device.

The demand for a server device for managing requests and responses to/from a network has recently increased as the use of services using networks such as social network services (SNS) has increased. In a SNS, users may be both content consumers and content providers. As the content is consumed/provided by a plurality of users, the amount of content which the server device manages has increased.

The number of server devices used by a SNS may be increased to manage the increasing content. However, server devices may be very expensive, and increasing the number of server devices may necessitate enormous expense. Accordingly, there is a focus on cost efficiently processing increased content without increasing the number of server devices.

### SUMMARY

Embodiments of the inventive concept provide a storage device which supports a function of a server device and an operating method of the storage device. Furthermore, embodiments of the inventive concept provide a storage device which has improved operating speed while supporting a function of the server device and an operating method of the storage device.

Embodiments of the inventive concept provide a storage device which includes an interface circuit configured to communicate with an external device, nonvolatile memory devices forming a plurality of partitions, and a processing circuit configured to receive a write request, a key, and a value from the interface circuit, to generate a partition identifier and a sort identifier from the received key, to select one of the partitions using the partition identifier, and to sort indexes of accumulated keys corresponding to the selected partition using sort identifiers included in the indexes.

Embodiments of the inventive concept provide a storage device which includes an interface circuit configured to communicate with an external device, nonvolatile memory devices forming a plurality of partitions, and a processing circuit configured to receive a read request and a key from the interface circuit, to generate a partition identifier and a sort identifier from the received key, to select one of the partitions using the partition identifier, and to search for indexes stored in the selected partition using sort identifiers.

Embodiments of the inventive concept provide an operating method of a storage device which includes a nonvolatile memory device, the operating method including receiving at the storage device a plurality of keys and values respectively corresponding to the keys, generating at the storage device a plurality of indexes including a plurality of sort identifiers respectively corresponding to the keys, sorting at the storage device the indexes by a unit of a first block size based on the sort identifiers and storing the sorted indexes in the nonvolatile memory device, storing the keys and the values in the nonvolatile memory device by a unit of a second block size, and upon determining at the storage device that a value corresponding to a specific key is requested, searching for the indexes using a sort identifier corresponding to the specific key by a unit of the first block size.

Embodiments of the inventive concept provide an operating method of a storage device which includes nonvolatile memory devices. The operating method may include receiving write requests and write data at the storage device, and writing indexes, generated from the write data, and the write data at the nonvolatile memory devices. The indexes may be written at the nonvolatile memory devices by a unit of a fixed size and may include patterns located with a predetermined period. The patterns may have values increasing or decreasing sequentially and the write data may be sequentially written in the nonvolatile memory devices in order of the write requests received.

Embodiments of the inventive concept provide an interface circuit configured to communicate with an external device; nonvolatile memory devices forming a plurality of partitions; and a processing circuit configured to receive an access request and a key from the interface circuit, to generate a partition identifier and a sort identifier from the received key, to select one of the partitions using the partition identifier, and to selectively sort indexes of accumulated keys corresponding to the selected partition using sort identifiers included in the indexes and search for indexes stored in the selected partition using the generated sort identifier responsive to the access request. The access request may be a write request or a read request.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 illustrates a block diagram of a server device according to an embodiment of the inventive concept;

FIG. 2 illustrates a diagram of an example in which a processor processes a write request based on a key-value store;

FIG. 3 illustrates a block diagram of a server device according to an embodiment of the inventive concept;

FIG. 4 illustrates a flow chart of an example in which a host and one of storage devices of a server device according to an embodiment of the inventive concept communicate with each other;

FIG. 5 illustrates a block diagram of a storage device according to an embodiment of the inventive concept;

FIG. 6 illustrates a flow chart of an operating method of a storage device according to an embodiment of the inventive concept;

FIG. 7 illustrates a flow chart of a write method of a storage device according to an embodiment of the inventive concept;

FIG. 8 illustrates a diagram of an example in which an identifier calculator generates a partition identifier calculator and a sort identifier;

FIG. 9 illustrates a block diagram of an example in which an IAB buffer and an OAB buffer are partitioned;

FIGS. 10, 11, 12, 13, 14 and 15 illustrate diagrams of the procedure in which an object processing circuit receives and processes objects;

FIG. 16 illustrates an example in which IABs are written at a k-th index partition of nonvolatile memory devices;

FIG. 17 illustrates a flow chart of a read method of a storage device according to an embodiment of the inventive concept;

FIG. 18 illustrates a flow chart of a method in which an IAB search unit determines a match;

FIG. 19 illustrates an example in which a search operation is performed using a sort identifier;

FIG. 20 illustrates an example in which IAB and OAB are written at a k-th partition;

FIGS. 21 and 22 illustrate diagrams of examples in which an IAB buffer, an OAB buffer, and nonvolatile memory devices are used;

FIG. 23 illustrates a block diagram of a storage device according to an embodiment of the inventive concept;

FIG. 24 illustrates a block diagram of a server system to which a storage device according to an embodiment of the inventive concept is applied;

FIG. 25 illustrates a block diagram of a server device in which a storage device according to an embodiment of the inventive concept is installed;

FIG. 26 illustrates a block diagram of a nonvolatile memory device according to an embodiment of the inventive concept; and

FIG. 27 illustrates a circuit diagram of a memory block according to an embodiment of the inventive concept.

### DETAILED DESCRIPTION

Exemplary embodiments of the inventive concept will now be more fully described with reference to the accompanying drawings.

As is traditional in the field of the inventive concepts, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the inventive concepts. Likewise, the blocks of the embodiments may be physically combined into more complex blocks without departing from the scope of the inventive concepts.

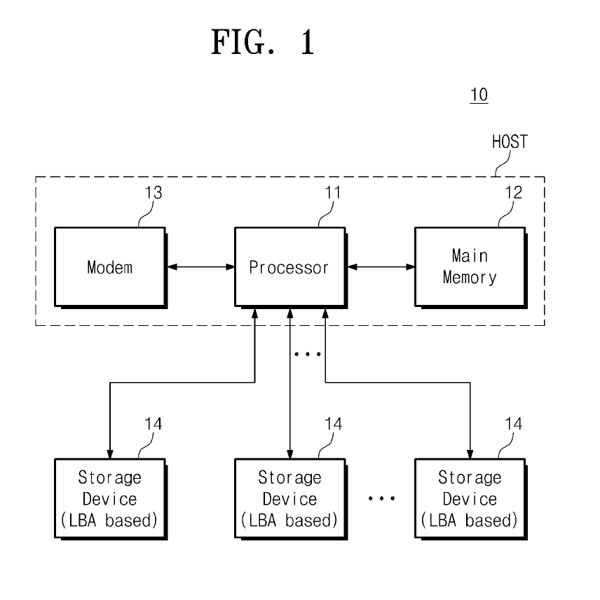

FIG. 1 illustrates a block diagram of a server device 10 according to an embodiment of the inventive concept. Referring to FIG. 1, server device 100 includes processor 11, main memory 12, modem 13, and storage devices 14.

The processor 11 may access the storage devices 14 in response to a request of an external device. For example, the processor 11 may read data from or write data at the storage devices 14 in response to the request of the external device. The processor 11 may perform arithmetic and control operations which are accomplished in writing data at the storage devices 14 and which are accomplished in reading data from the storage devices 14. The processor 11 may use the main memory 12 as a working memory, a buffer memory, a cache memory, or a temporary memory. The processor 11 may receive a request from the external device through the modem 13 or may transmit a response to the external device through the modem 13. The processor 11, the main memory 12, and the modem 13 may operate as a host (HOST) of the storage devices 14.

The storage devices 14 may be accessible based on a logical address (LBA). For example, logical addresses may be assigned to each storage device 14 by the processor 11. A storage space of each storage device 14 may be distinguished by assigned logical addresses (LBA based).

For example the storage devices 14 may receive a logical address and write data from the processor 11, and may write the write data at a storage space which the logical address indicates. The storage devices 14 may receive a logical address from the processor 11 and may read data from a storage space which the logical address indicates. The read data may be provided to the processor 11.

The server device 10 may receive a write request or a read request from the external device through the modem 13. The write request or the read request may be performed based on a key-value store.

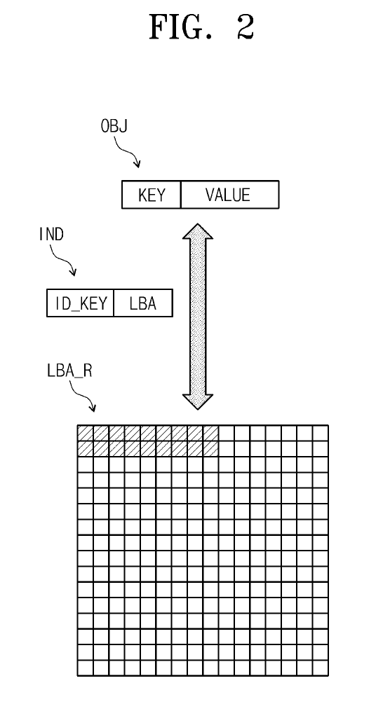

FIG. 2 illustrates a diagram of an example in which processor 11 processes a write request based on a key-value store. Referring to FIGS. 1 and 2, the processor 11 receives a write request, including a key and a value, from the external device. The value may include write data. The key may be a unique identifier of the value. A pair of the key and the value may be referred as an object OBJ.

During a write operation, the processor 11 may be requested to store the key and the value at a logical address area LBA_R of the storage devices 14 for example, which is a portion marked with oblique lines.

During a read operation, the processor 11 may receive the key from the external device and may read the value using the key. For example, when storing the key and the value at the logical address area LBA_R, the processor 11 may generate an index IND, indicating that a relation between a logical address LBA of an area, at which the key and the value are stored, and an identifier ID_KEY in the form of a table. The identifier ID_KEY may be the key or information which is generated from the key and is associated with the key.

If the index IND is generated, the processor 11 may search for an index, corresponding to the key, from among indexes and may obtain a logical address LBA, at which the key and the value are stored, based on the found index.

The server device 10 described with reference to FIGS. 1 and 2 may be limited in terms of expandability of the storage devices 14. For example, if the number of the storage devices 14 in the server device 10 increases, the number of objects OBJ to be written at the storage devices 14 may also increase, which may also increase the number of indexes which the processor 11 manages. That is, if the number of the storage devices 14 increases, the resources needed for the processor 11 to manage the increased number of indexes (e.g., a capacity of the main memory 12 or the number of the main memories 12) may increase. That is, an increase in storage devices 14 in the server device 10 may result in expense needed to expand the main memory 12 in addition to the expense needed to add the storage devices 14. For this reason, the server device 10 which uses LBA-based storage devices may be limited in terms of expandability of the storage devices 14.

A storage device which is based not on a logical block addressing (LBA) but on an object (OBJ), and a server device using the object-based storage device with improved expandability, will now be described.

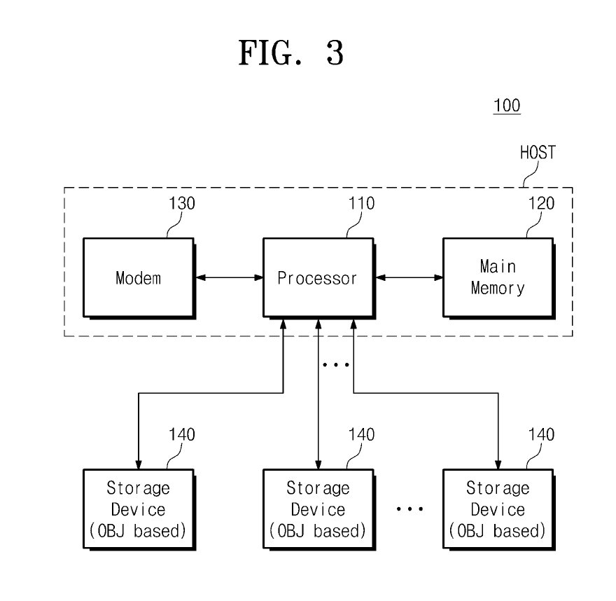

FIG. 3 illustrates a block diagram of a server device 100 according to an embodiment of the inventive concept. Referring to FIG. 3, a server device 100 includes a processor 110, a main memory 120, a modem 130, and storage devices 140.

The processor 110 may access the storage devices 140 in response to a request of the external device. For example, the processor 110 may write data to or read data from the storage devices 140 in response to a request from the external device. The processor 110 may perform arithmetic and control operations which are accompanied with writing data at the storage devices 140 and which are accompanied with reading data from the storage devices 140.

The processor 110 may use the main memory 120 as a working memory, a buffer memory, or a cache memory. The main memory 120 may include for example at least one of a volatile random access memory, such as, but not limited to, a static RAM (SRAM), a dynamic RAM (DRAM) or a nonvolatile memory such as a phase-change RAM (PRAM), a magnetic RAM (MRAM), a resistive RAM (RRAM), or a ferroelectric RAM (FeRAM).

The processor 110 may receive a request from the external device through the modem 130 or may transmit a response to the external device. The modem 130 may communicate with the external device based on the Ethernet. The modem 130 may communicate with the external device, based on for example at least one of wireless communication such as long term evolution (LTE), WiMax, global system for mobile communication (GSM), code division multiple access (CDMA), Bluetooth, near field communication (NFC), Wi-Fi, radio frequency identification (RFID), and the like, or wired communication such as universal serial bus (USB), SATA, HSIC, SCSI, Firewire, peripheral component interconnection (PCI), PCI express (PCIe), nonvolatile memory express (NVMe), universal flash storage (UFS), secure digital (SD), SDIO, universal asynchronous receiver transmitter (UART), serial peripheral interface (SPI), high speed SPI (HS-SPI), RS232, inter-integrated circuit (I2C), HS-I2C, integrated-interchip sound (I2S), Sony/Philips digital interface (S/PDIF), multimedia card (MMC), embedded MMC (eMMC), and so on.

The processor 110, the main memory 120, and the modem 130 may operate as a host (HOST) of the storage devices 140.

Unlike the storage devices 14 described with reference to FIGS. 1 and 2, the storage devices 140 may operate based on an object OBJ. Upon receiving a write request including a key and a value from the external device, the processor 110 may transmit the write request including the key and the value to one of the storage devices 140. Upon receiving a read request including a key from the external device, the processor 110 may transmit the read request including the key to one of the storage devices 140.

The storage devices 140 may perform read and write operations based on an object OBJ including the key and the value. The storage devices 140 may automatically generate and manage an index indicating a relation between a key and a logical address LBA. Accordingly, in the case where the number of storage devices 140 in the server device 100 increases, an increase in additional resources of the server device 100 other than the storage devices 140 may not be necessary, and thus expandability of the storage devices 140 of the server device may be improved.

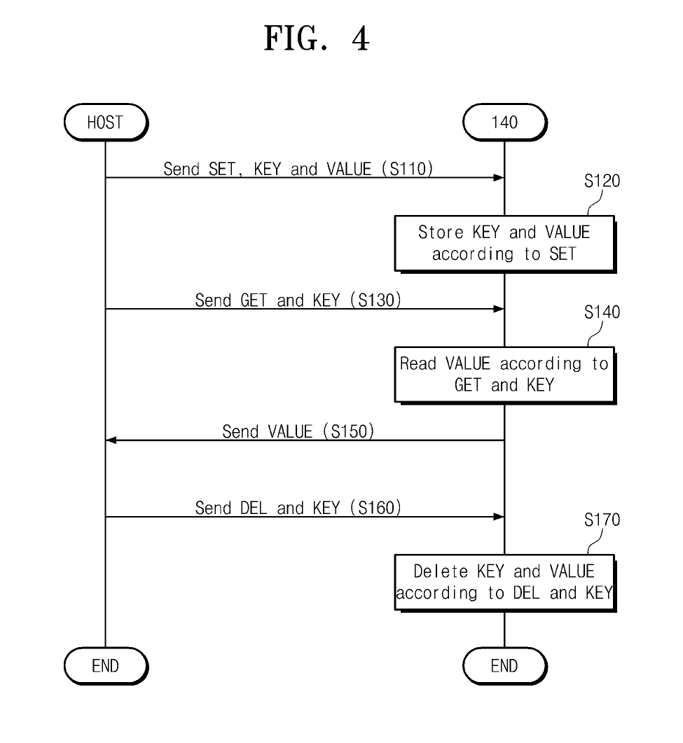

FIG. 4 illustrates a flow chart of an example in which a host and one of storage devices 140 of a server device 100 according to an embodiment of the inventive concept communicate with each other. Referring to FIGS. 3 and 4, in step S110, a host sends a write request SET, a key, and a value to the storage device 140. In step S120, the storage device 140 stores the key and the value in response to the write request SET.

In step S130, the host sends a read request GET and a key to the storage device 140. In step S140, the storage device 140 reads a value in response to the read request GET and the key. In step S150, the storage device 140 sends the read value to the host.

In step S160, the host sends a delete request DEL and a key to the storage device 140. In step S170, the storage device 140 deletes a key and a value in response to the delete request DEL and the key.

As described with reference to FIG. 4, the storage devices 140 may process a request which is based on a key-value store generated outside the server device 100. In this case, a load of the host may be reduced, and thus expandability of the storage devices 140 may be improved.

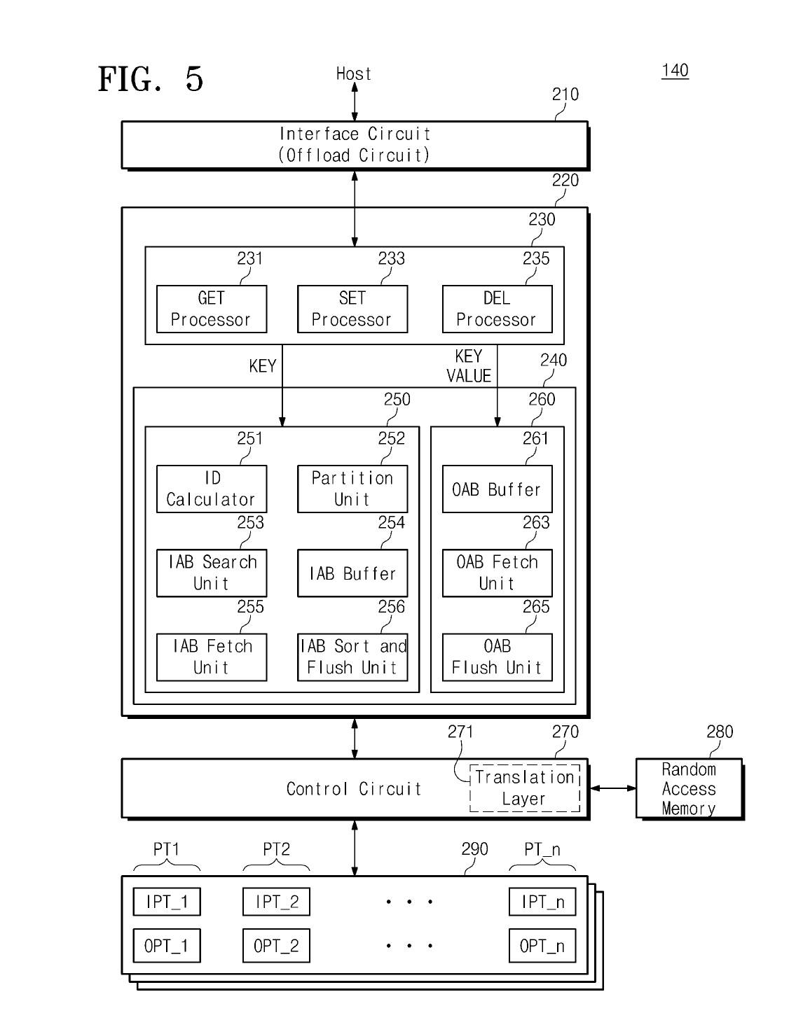

FIG. 5 illustrates schematically a block diagram of a storage device 140 according to an embodiment of the inventive concept. Referring to FIGS. 4 and 5, the storage device 140 includes an interface circuit 210, an object processing circuit 220, a control circuit 270, a random access memory 280, and nonvolatile memory devices 290.

The interface circuit 210 may communicate with the host based on the Ethernet for example. The interface circuit 210 may include an offload circuit which is configured to perform TCP/IP-based packetizing and depacketizing. For example, the offload circuit may be an independent hardware circuit which is configured to perform functions for automatically achieving an object without the aid of an external processing device such as the object processing circuit 220 or any other core circuit. The offload circuit may provide excellent operating speed compared with when performing functions through software driven resources on the external processing device. Furthermore, if the offload circuit is used, flow may be easily controlled without consuming resources of an external processing device, and thus an operating speed of the storage device 140 may be improved.

The interface circuit 210 is not limited to communicating with the host based on the Ethernet. In embodiments of the inventive concept interface circuit 210 may communicate with the external device, based on for example at least one of wireless communication such as long term evolution (LTE), WiMax, global system for mobile communication (GSM), code division multiple access (CDMA), Bluetooth, near field communication (NFC), Wi-Fi, radio frequency identification (RFID), and the like or wired communication such as universal serial bus (USB), SATA, HSIC, SCSI, Firewire, peripheral component interconnection (PCI), PCI express (PCIe), nonvolatile memory express (NVMe), universal flash storage (UFS), secure digital (SD), SDIO, universal asynchronous receiver transmitter (UART), serial peripheral interface (SPI), high speed SPI (HS-SPI), RS232, inter-integrated circuit (I2C), HS-I2C, integrated-interchip sound (I2S), Sony/Philips digital interface (S/PDIF), multimedia card (MMC), embedded MMC (eMMC), and so on.

The object processing circuit 220 processes an OBJ-based request received through the interface circuit 210. The object processing circuit 220 converts the OBJ-based request into an LBA-based request and sends the converted request to the control circuit 270. The object processing circuit 220 converts an LBA-based response, received from the control circuit 270, into an OBJ-based response. The object processing circuit 220 outputs the OBJ-based response through the interface circuit 210.

The object processing circuit 220 includes a request control part 230 and an object managing part 240. The request control part 230 may be configured to process the OBJ-based request received from the host. For example, the request control part 230 includes a write (SET) processor 233 controlling the object managing part 240 such that the object managing part 240 performs an overall operation for performing a write request when the OBJ-based request is a write request SET; a read (GET) processor 231 controlling the object managing part 240 such that the object managing part 240 performs an overall operation for performing a read request when the OBJ-based request is a read request GET; and a delete (DEL) processor 235 controlling the object managing part 240 such that the object managing part 240 performs an overall operation for performing a delete request when the OBJ-based request is a delete request DEL.

The object managing part 240 may process either a key, or a key and a value, under control of the request control part 230. The object managing part 240 includes an index array block (IAB) manager 250 configured to generate and manage an index from a key and an object array block (OAB) manager 260 configured to manage a key and a value.

The IAB manager 250 includes an identifier (ID) calculator 251, a partition unit 252, an index array block (IAB) search unit 253, an IAB buffer 254, an IAB fetch unit 255, and an IAB sort and flush unit 256.

The identifier calculator 251 may be configured to generate one or more identifiers from a key. The partition unit 252 may be configured to select one of partitions PT_1 to PT_n of the nonvolatile memory devices 290, based on at least one first identifier generated by the identifier calculator 251. The IAB search unit 253 may be configured to search for at least one second identifier, generated by the identifier calculator 251, from the selected partition. The IAB buffer 254 may be configured to store generated indexes. The IAB fetch unit 255 may be configured to fetch an IAB from the selected partition in response to a read request GET (e.g., may request the IAB to the control circuit 270). If the size of indexes accumulated in the IAB buffer 254 reaches a block size, the IAB sort and flush unit 256 may sort or align indexes based on second identifiers generated by the identifier calculator 251 and may flush the sorted indexes onto the control circuit 270.

The OAB manager 260 includes an object array block (OAB) buffer 261, an OAB fetch unit 264, and an OAB flush unit 265. The OAB buffer 261 may be configured to store an object, including a key and a value, received from the host. The OAB fetch unit 263 may be configured to request an OAB, corresponding to an address found by the IAB manager 250, to the control circuit 270. If the size of objects accumulated in the OAB buffer 261 reaches a block size, the OAB flush unit 265 may be configured to flush the accumulated objects onto the control circuit 270 as an OAB.

The control circuit 270 may be configured to receive a flush request (or a write request) and a fetch request (or a read request), which are based on a logical address LBA, from the object managing part 240. The control circuit 270 may be configured to translate a logical address LBA to a physical address PBA of the nonvolatile memory devices 290 using a flash translation layer 271. The control circuit 270 may access the nonvolatile memory devices 290 based on the physical address PBA. The control circuit 270 may use the random access memory 280 as a working memory, a buffer memory, a cache memory, or a temporary memory. The random access memory 280 may for example include a DRAM, an SRAM, a PRAM, an MRAM, an RRAM, a FeRAM, or the like. The control circuit 270 may store data required for managing the nonvolatile memory devices 290, or translating the logical address LBA, into the physical address PBA into the random access memory 280.

The nonvolatile memory devices 290 may be partitioned into two or more partitions PT_1 to PT_n. For example, the partitions PT_1 to PT_n may be created on a logical address area LBA_R of the nonvolatile memory devices 290. The partitions PT_1 to PT_n may include index partitions IPT_1 to IPT_n and object partitions OPT_1 to OPT_n. The IAB may be stored in the index partitions IPT_1 to IPT_n, and the OAB may be stored in the object partitions OPT_1 to OPT_n. The nonvolatile memory devices 290 may include for example a flash memory device, a PRAM, an MRAM, an RRAM, a FeRAM, or the like.

Each of blocks (e.g., units or parts) constituting the storage device 140 may be implemented with hardware, software, or a combination of hardware and software. Functions of blocks constituting the storage device 140 will be described in detail below.

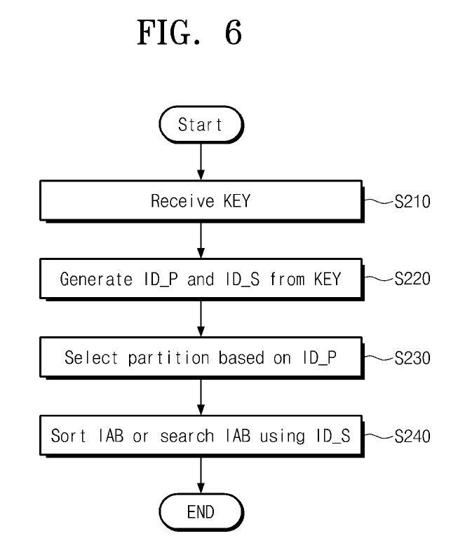

FIG. 6 illustrates a flow chart of an operating method of a storage device 140 according to an embodiment of the inventive concept. Referring to FIGS. 5 and 6, in step S210, the storage device 140 receives a key through the interface circuit 210. In an embodiment, a value may be further received if the key is associated with a write request SET. If the key is associated with a read request GET or a delete request DEL, a value may not be received.

In step S220, the identifier calculator 251 generates a partition identifier ID_P and a sort identifier ID_S from the received key.

In step S230, the partition unit 252 selects one of partitions PT_1 to PT_n of the nonvolatile memory devices 290, based on the partition identifier ID_P.

In step S240, the IAB manager 250 may sort indexes (for example, the IAB) using the sort identifier ID_S or may search for indexes (for example, the IAB) using the sort identifier ID_S.

The storage device 140 according to an embodiment of the inventive concept may further use the sort identifier ID_S, which is used for sorting and searching, other than the partition identifier ID_P. The sort identifier ID_S may make it easy to write and search for indexes, and thus an operating speed of the storage device 140 may be improved.

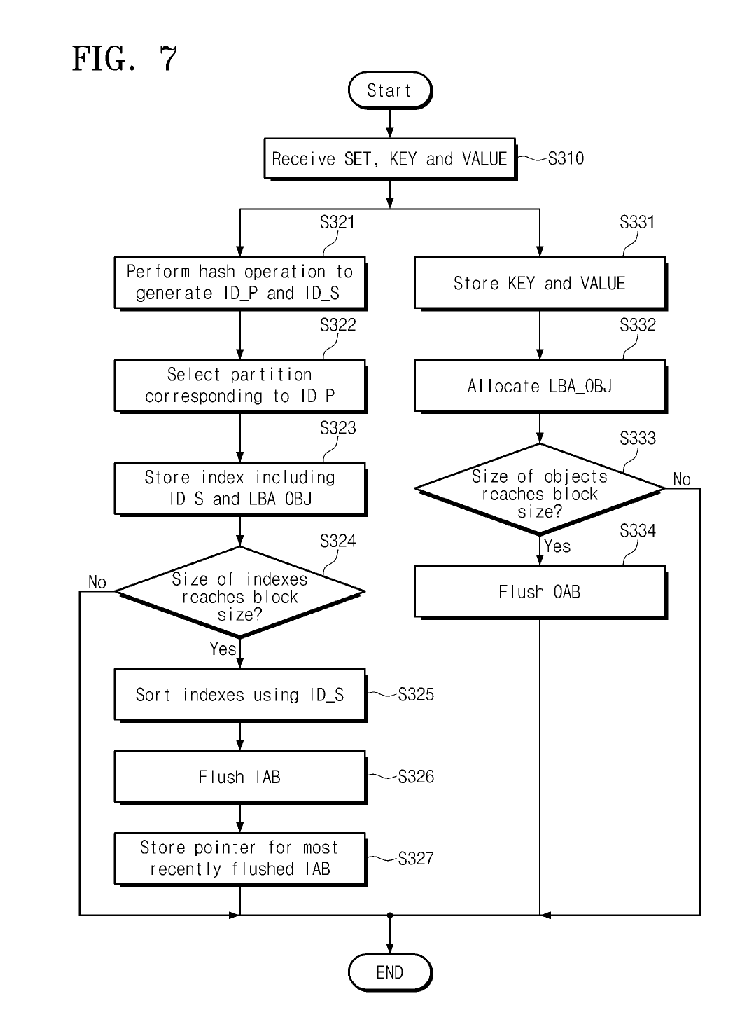

FIG. 7 illustrates a flow chart of a write method of a storage device 140 according to an embodiment of the inventive concept. Referring to FIGS. 5 and 7, in step S310, the object processing circuit 220 receives a write request SET, a key, and a value through the interface circuit 210.

Afterwards, a control flow may be divided into the IAB manager 250 and the OAB manager 260. The left control flow marked by step numbers S32X may be performed by the IAB manager 250. A right control flow marked by step numbers S33X may be performed by the OAB manager 260. The control flow of the IAB manager 250 and the control flow of the OAB manager 260 may be performed independently of each other.

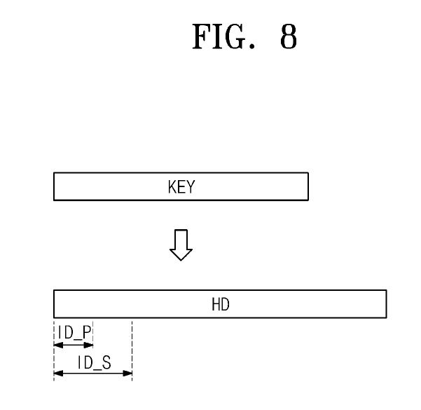

The control flow of the IAB manager 250 is as follows. In step S321, the identifier calculator 251 generates a partition identifier ID_P and a sort identifier ID_S by performing a hash operation (or function) with respect to the key. FIG. 8 illustrates an example in which the identifier calculator 251 generates the partition identifier ID_P and the sort identifier ID_S. Referring to FIGS. 5 and 8, the identifier calculator 251 may generate hash data HD by performing a hash operation (or function), for example an MD5 hash operation (or function) with respect to the key. The identifier calculator 251 may select some bits of the hash data HD as the partition identifier ID_P and some bits of the hash data HD as the sort identifier ID_S. The size of the sort identifier ID_S may be greater than that of the partition identifier ID_P and may be smaller than that of the key. The sort identifier ID_S may include the partition identifier ID_P. However, other embodiments of the inventive concept are not limited thereto.

Referring to. FIGS. 5 and 7, in step S322, the partition unit 252 selects a partition corresponding to the partition identifier ID_P. The partition unit 252 may manage a relation between partitions PT_1 to PT_n of the nonvolatile memory devices 290 and bit patterns of the partition identifier ID_P in the form of a table. The partition unit 252 may select one of the partitions PT_1 to PT_n based on a bit pattern of the partition identifier ID_P. Information about the selected partition may be sent to the OAB manager 260.

In step S323, the IAB buffer 254 stores an index including an object logical address LBA_OBJ and the sort identifier ID_S. The object logical address LBA_OBJ may be a logical address LBA on a selected partition of the nonvolatile memory devices 290 at which an object OBJ including a key and a value is to be stored. For example, the object logical address LAB_OBJ may be generated by the OAB manager 260 and may be sent to the IAB manager 250. As another example, the object logical address LBA_OBJ may be internally calculated by the IAB manager 250. For example, the OAB may be written at logical addresses LBA which sequentially increase or decrease. Since the size of the OAB is fixed, the IAB manager 250 is able to calculate an object logical address OBJ_LBA at which the OAB is to be written.

The IAB buffer 254 may include a plurality of indexes respectively corresponding to the partitions PT_1 to PT_n of the nonvolatile memory devices 290. A generated index may be stored in an index buffer corresponding to a selected partition.

In step S324, the IAB sort and flush unit 256 determines whether the size of indexes accumulated in the index buffer corresponding to the selected partition reaches a block size. If the size of the accumulated indexes does not reach the block size, an operation of the IAB manager 250 may be ended. If the size of the accumulated indexes reaches the block size, in step S325, the IAB sort and flush unit 256 may sort (or align) indexes in the index buffer using the sort identifier ID_S. For example, the IAB sort and flush unit 256 may sort indexes in an ascending or descending order, based on values of bits of the sort identifier ID_S. In step S326, the IAB sort and flush unit 256 flushes the sorted indexes onto the control circuit 270 as an IAB. Afterwards in step S327, a pointer about an IAB most recently flushed from the selected partition may be stored or updated in the IAB fetch unit 255. The control circuit 270 may write the IAB at a selected index partition of the selected partition in response to a flush request.

The control flow of the OAB manager 260 is as follows. In step S331, the OAB buffer 261 stores the key and the value. For example, the key and the value may be stored to be correlated as a log-structured pair. For example, the OAB buffer 261 may include a plurality of object buffers respectively corresponding to the partitions PT_1 to PT_n of the nonvolatile memory devices 290. An object OBJ may be stored in an object buffer corresponding to a selected partition.

In step S332, an object logical address LBA_OBJ indicating a location of a selected partition where an object OBJ is to be stored is allocated. For example, the object logical address LBA_OBJ may be selected from logical addresses of an object partition of the selected partition. The object logical address LBA_OBJ may be sent to the IAB manager 250.

In step S333, the OAB flush unit 265 determines whether the size of objects accumulated in the object buffer of the OAB buffer 261 corresponding to the selected partition reaches a block size. If the size of the accumulated objects does not reach the block size, an operation of the OAB manager 260 may be ended. If the size of the accumulated objects reaches the block size, in step S334 the OAB flush unit 265 flushes the accumulated objects onto the control circuit 270 as an OAB. The control circuit 270 may write the OAB at a selected object partition of the selected partition.

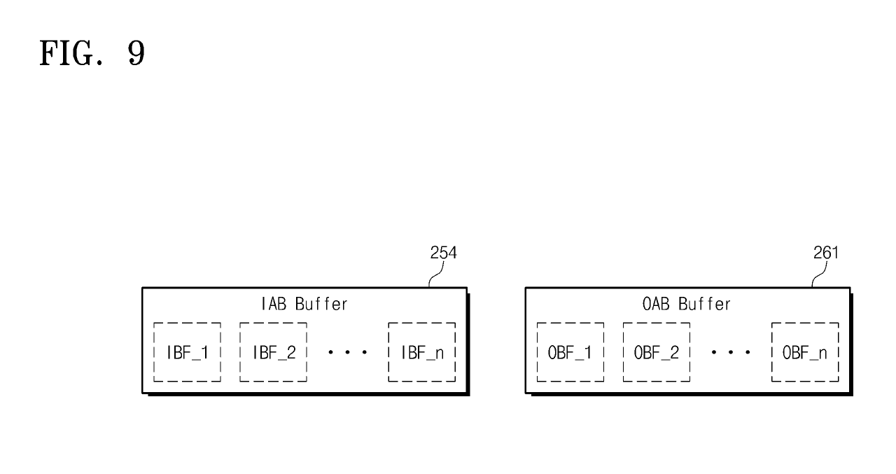

FIG. 9 is a block diagram illustrating an example in which an IAB buffer 254 and an OAB buffer 261 are partitioned. Referring to FIGS. 5 and 9, as a logical storage space of nonvolatile memory devices 290 identified by logical addresses are divided into partitions PT_1 to PT_n, the IAB buffer 254 and the OAB buffer 261 may similarly be respectively divided into index buffers IBF_1 to IBF_n and object buffers OBF_1 to OFB_n. The index buffers IBF_1 to IBF_n may store indexes to be written at the index partitions IPT_1 to IPT_n. The object buffers OBF_1 to OBF_n may store objects to be written at the object partitions OPT_1 to OPT n.

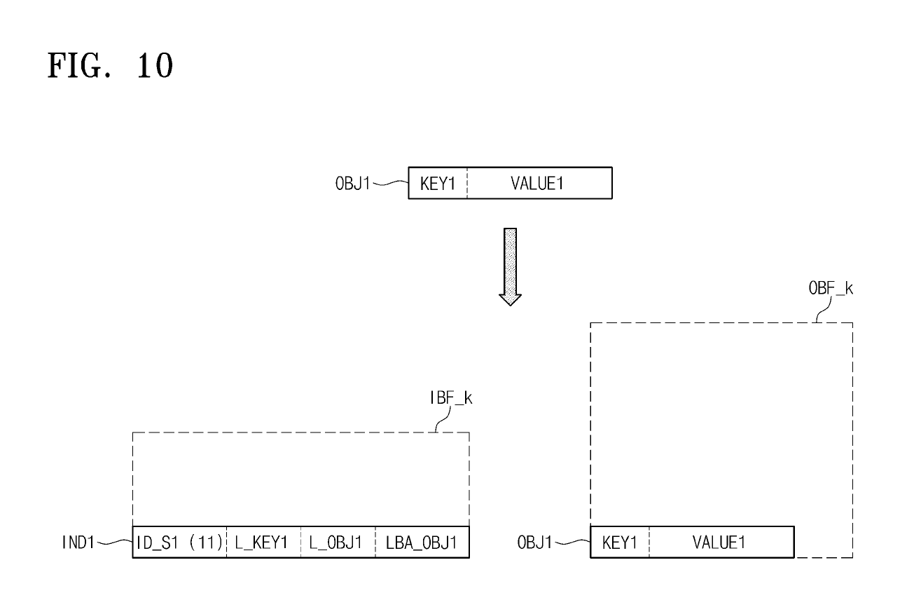

FIGS. 10 to 15 illustrate diagrams of the procedure in which an object processing circuit 220 receives and processes objects. In an embodiment, an example in which a write request about a k-th (k being a positive integer) partition PT_K is iteratively received is illustrated in FIGS. 10 to 15. That is, in FIGS. 10 to 15, a partition identifier ID_P may indicate the k-th partition PT_k. Since the partition identifier ID_P indicates the k-th partition PT_k, index buffers and object buffers other than the k-th index buffer IBF_k and the k-th object buffer OBF_k which are associated with the k-th partition PT_k are not illustrated in FIGS. 10 to 15.

Referring to FIGS. 5 and 10, there may be received a write request SET of a first object OBJ1 including a first key KEY1 and a first value VALUE1. The IAB manager 250 may generate a first index IND1 associated with the first key KEY1 and may store the first index IND1 in the k-th index buffer IBF_k. In an embodiment, the first index IND1 may include a first sort identifier ID_S1, which is generated from the first key KEY1, and a first object logical address LBA_OBJ1. The first sort identifier ID_S1 may have a value of “11”. The first object logical address LBA_OBJ1 may be a logical address of a k-th object partition OPT_k of the k-th partition PT_k of the nonvolatile memory devices 290 corresponding to a position where the first object OBJ1 is to be written. In an embodiment, the first index IND1 may further include length information L_KEY1 (first length information) of the first key KEY1 or length information L_OBJ1 (second length information) of the first object OBJ1. The length information L_KEY1 and the length information L_OBJ1 may be used to improve accuracy when a search operation is performed according to a read request. The OAB manager 260 may store the first object OBJ1 including the first key KEY1 and the first value VALUE1 in the k-th object buffer OBF_k.

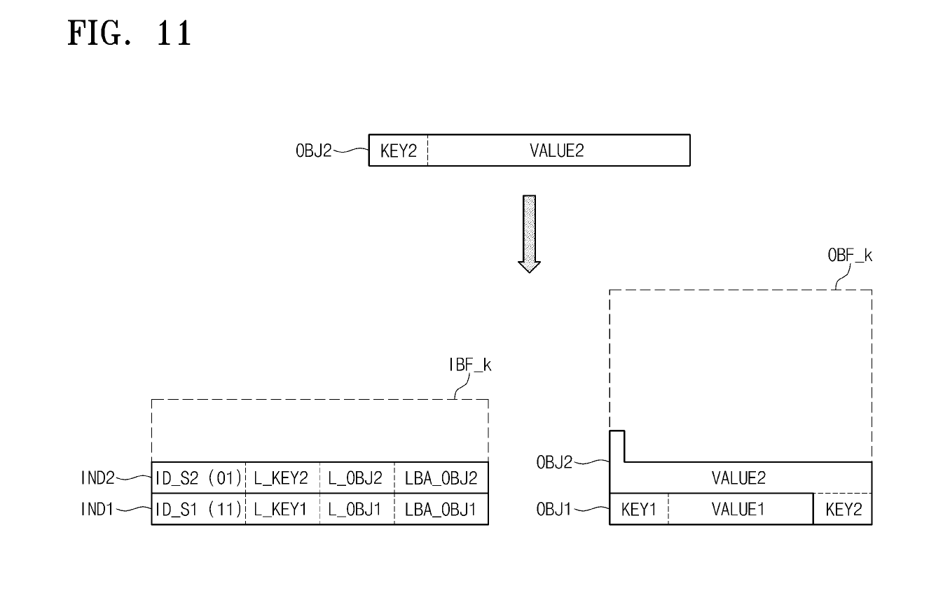

Referring to FIGS. 5 and 11, there may be received a second object OBJ2 including a second key KEY2 and a second value VALUE2. The OAB manager 250 may store a second index IND2 associated with the second key KEY2 in the k-th index buffer IBF_k. The second index IND2 may include a second sort identifier ID_S2 having a value of “01”, a second object logical address LBA_OBJ2, length information L_KEY2 of the second key KEY2, and length information L_OBJ2 of the second object OBJ2. The OAB manager 260 may store the second key KEY2 and the second value VALUE2 in the k-th object buffer OBF_k.

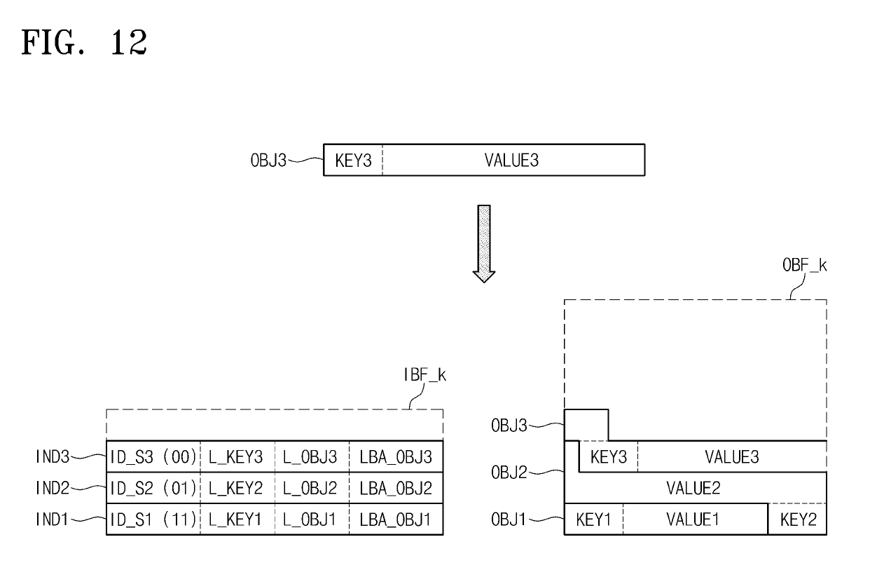

Referring to FIGS. 5 and 12, there may be received a third object OBJ3 including a third key KEY3 and a third value VALUE3. The IAB manager 250 may store a third index IND3 associated with the third key KEY3 in the k-th index buffer IBF_k. The third index IND3 may include a third sort identifier ID_S3 having a value of “00”, a third object logical address LBA_OBJ3, length information L_KEY3 of the third key KEY3, and length information L_OBJ3 of the third object OBJ3. The OAB manager 260 may store the third key KEY3 and the third value VALUE3 in the k-th object buffer OBF_k.

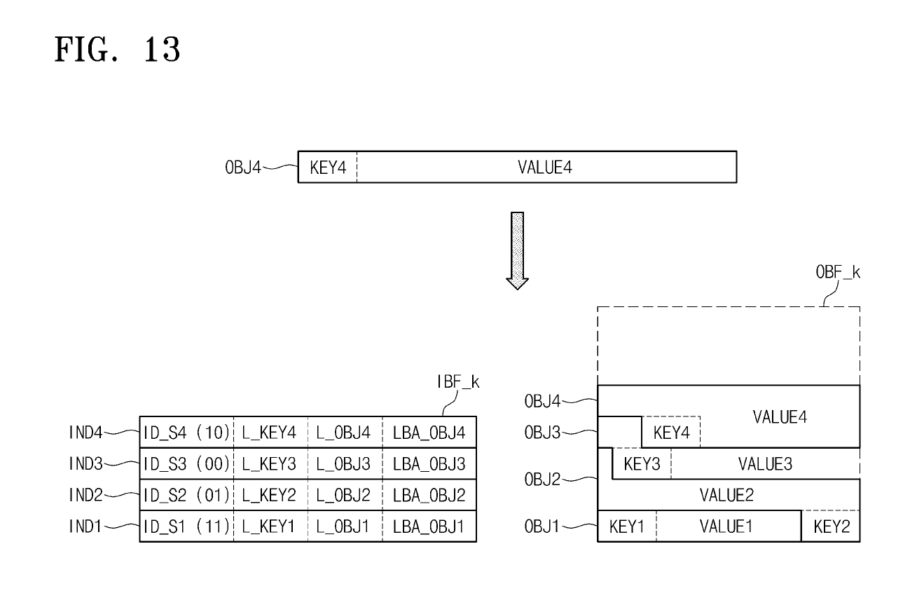

Referring to FIGS. 5 and 13, there may be received a fourth object OBJ4 including a fourth key KEY4 and a fourth value VALUE4. The IAB manager 250 may store a fourth index IND4 associated with the fourth key KEY4 in the k-th index buffer IBF_k. The fourth index IND4 may include a fourth sort identifier ID_S4 having a value of “10”, a fourth object logical address LBA_OBJ4, length information L_KEY4 of the fourth key KEY4, and length information L_OBJ4 of the fourth object OBJ4. The OAB manager 260 may store the fourth key KEY4 and the fourth value VALUE4 in the k-th object buffer OBF_k.

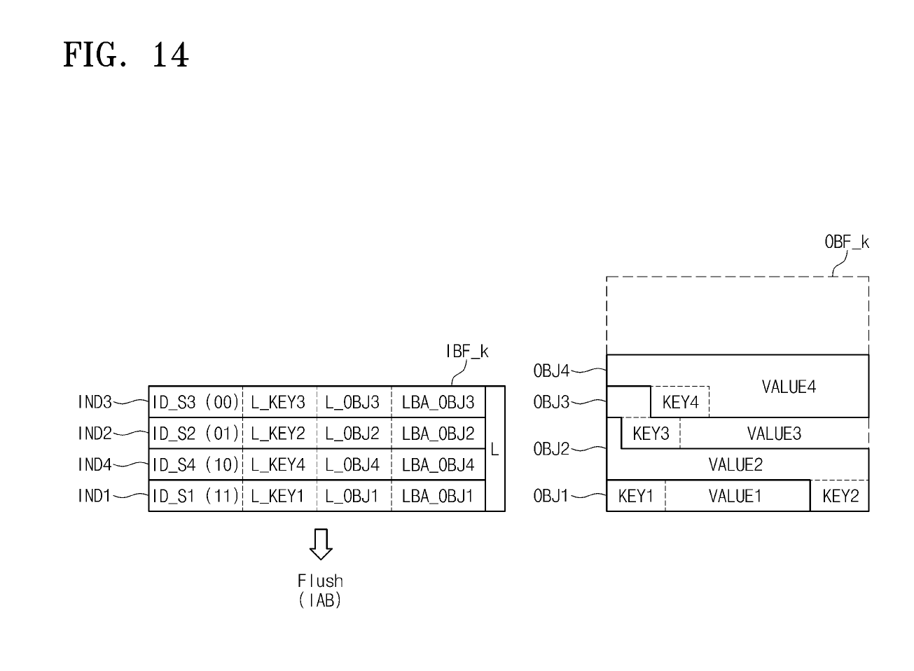

Referring to FIGS. 5 and 14, the size of the indexes IND1 to IND4 may reach a block size. The IAB sort and flush unit 256 may sort the indexes IND1 to IND4, as illustrated in FIG. 14, based on sort indexes ID_S1 to ID_S4. The IAB sort and flush unit 256 may add a link L to the sorted indexes IND1 to IND4. In an embodiment, in the case where an IAB previously flushed does not exist in a selected k-th index partition IPT_k, the link L may indicate a start logical address or a last logical address of the k-th index partition IPT_k or null information. In the case where the IAB previously flushed exists in the selected k-th index partition IPT_k, the link L may indicate a start logical address or a last logical address of an IAB most recently flushed or written at the k-th index partition IPT_k. Afterwards, the indexes IND1 to IND4 which are sorted and to which the link L is added may be flushed as an IAB. As the IAB is being most recently flushed, a start logical address or a last logical address of the flushed IAB may be stored or updated in the IAB fetch unit 255.

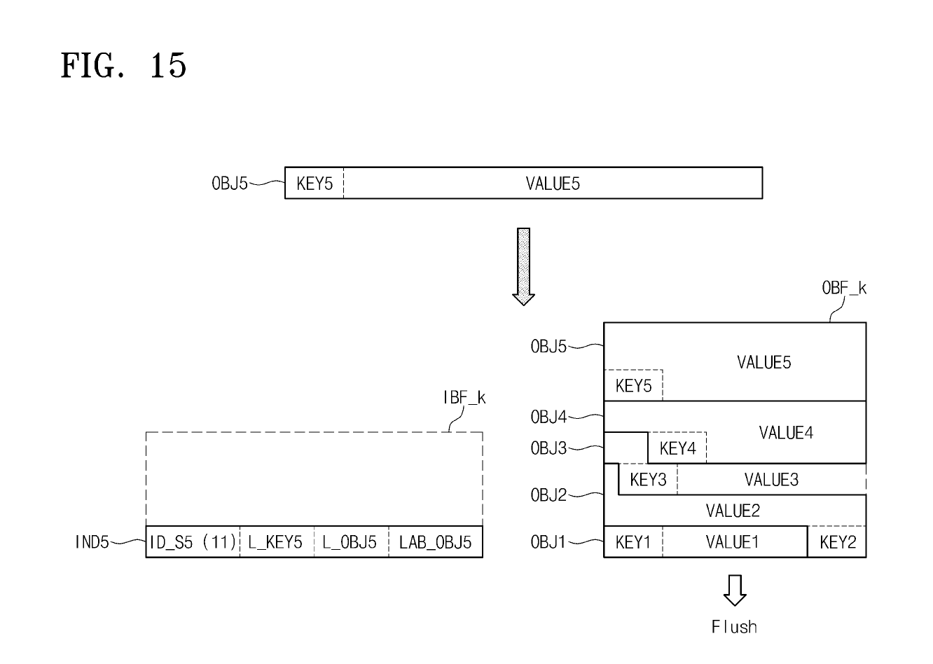

Referring to FIGS. 5 and 15, there may be received a fifth object OBJ5 including a fifth key KEY5 and a fifth value VALUE5. The IAB manager 250 may store a fifth index IND5 associated with the fifth key KEY5 in the k-th index buffer IBF_k. The fifth index IND5 may include a fifth sort identifier ID_S5 having a value of “11”, a fifth object logical address LBA_OBJ5, length information L_KEY5 of the fifth key KEY5, and length information L_OBJ5 of the fifth object OBJ5.

The OAB manager 260 may store the fifth key KEY5 and the fifth value VALUE5 in the k-th object buffer OBF_k. As the fifth object OBJ5 is stored in the k-th object buffer OBF_k, the size of accumulated objects OBJ1 to OBJ5 may reach a block size. The OAB flush unit 265 may flush the accumulated objects OBJ1 to OBJ5 as an OAB.

As described above, the IAB and the OAB may be accumulated and flushed independently of each other. If the size of accumulated indexes reaches a size of the IAB, indexes may be sorted, a link L may be added to the sorted indexes, and the sorted indexes to which the link L is added may be flushed as an IAB. If the size of accumulated objects reaches a size of the OAB, the objects may be flushed as an OAB. In an embodiment, the size of the IAB may be determined in consideration of a size fit to efficiently perform write and read operations about the nonvolatile memory devices 290, an area and a cost for the IAB buffer 254, a time taken to sort indexes, a time taken to perform a search operation, and the like. In an embodiment, the size of the OAB may be determined in consideration of a size fit to efficiently perform write and read operations about the nonvolatile memory devices 290 or an area and a cost for the OAB buffer 261.

As illustrated in FIGS. 10 to 15, in the objects OBJ1 to OBJ5, sizes of the keys KEY1 to KEY5 may be fixed, and sizes of the values VALUE1 to VALUE5 may be variable. However, in other embodiments sizes of the keys KEY1 to KEY5 and sizes of the values VALUE1 to VALUE5 all may be variable.

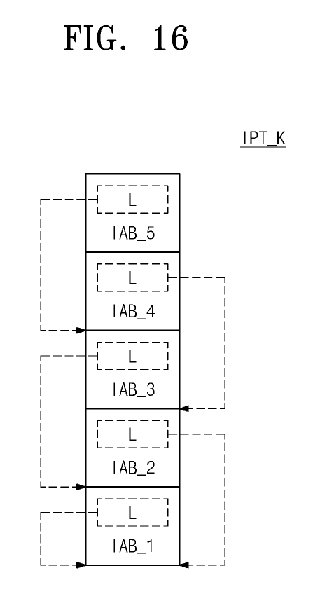

FIG. 16 illustrates an example in which IABs are written at a k-th index partition IPT_k of nonvolatile memory devices. Referring to FIGS. 5 and 16, IABs may have the same size. IAB_1 may be an IAB which is first written at the k-th index partition IPT_k. IAB_1 may be sequentially written in a direction where an address increases or decreases from a start logical address or a last logical address of the k-th index partition IPT_k. A link L added when the IAB_1 is flushed may indicate a start address or a last address of the k-th index partition IPT_k or may have a null value. When the IAB_1 is flushed, the IAB fetch unit 255 may store a pointer (or an address) indicating the IAB_1 flushed most recently at the k-th index partition IPT_k.

IAB_2 following the IAB_1 may be written at the k-th index partition IPT_k. IAB_2 may be sequentially written in a direction where an address increases or decreases from a start logical address or a last logical address of the IAB_1. A link L added to the IAB_2 may indicate a start address or a last address of the IAB_1 being a previous IAB. When the IAB_2 is flushed, the IAB fetch unit 255 may store a pointer (or an address) indicating the IAB_2 flushed most recently at the k-th index partition IPT_k.

IAB_3 following the IAB_2 may be written at the k-th index partition IPT_k. IAB_3 may be sequentially written in a direction where an address increases or decreases from a start logical address or a last logical address of the IAB_2. A link L added to the IAB_3 may indicate a start address or a last address of the IAB_2 being a previous IAB. When the IAB_3 is flushed, the IAB fetch unit 255 may store a pointer (or an address) indicating the IAB_3 flushed most recently at the k-th index partition IPT_k.

IAB_4 following the IAB_3 may be written at the k-th index partition IPT_k. IAB_4 may be sequentially written, a link L added, and when flushed IAB fetch unit 255 may store a pointer in a similar manner as described above with respect to IAB_2 and IAB_3.

IAB_5 following the IAB_4 may be written at the k-th index partition IPT_k.

As illustrated in FIG. 16, IABs may be managed in the form of a linked list. A pointer (or an address) indicating the most recently flushed IAB may be stored in the IAB fetch unit 255. Each IAB may include indexes sorted according to a sort identifier ID_S. When a read request GET is received, the IAB fetch unit 255 may fetch the most recently flushed IAB at a selected index partition using the stored pointer (or the stored address). If an index corresponding to a key associated with the read request GET is not found from the fetched IAB, a next IAB may be fetched based on a link L. As described above, a search operation about indexes may be accelerated by sorting indexes using a sort identifier ID_S at each IAB. Furthermore, since indexes of a partition are divided into a plurality of IABs, the size of the IABs may be adjusted, thereby making it possible to tune a search speed. In addition, a plurality of IABs may be managed with a linked list, and thus resources needed to manage the IABs may be reduced.

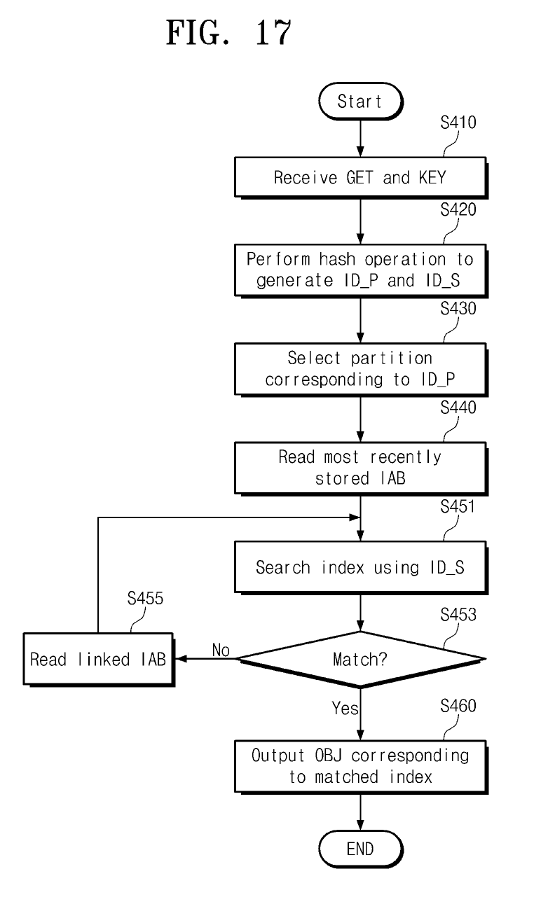

FIG. 17 illustrates a flow chart of a read method of a storage device 140 according to an embodiment of the inventive concept. Referring to FIGS. 5 and 17, in step S410, the object processing circuit 220 receives a key through the interface circuit 210.

In step S420, the identifier calculator 251 generates a partition identifier ID_P and a sort identifier ID_S by performing a hash operation with respect to the key.

In step S430, the partition unit 252 selects one of partitions PT_1 to PT_n of the nonvolatile memory devices 290, based on the partition identifier ID_P.

In step S440, the IAB fetch unit 255 fetches the most recently fetched IAB using a pointer (or an address) indicating the IAB most recently fetched at the selected partition. For example, in the selected partition, in the case where IABs are written as illustrated in FIG. 16, the IAB fetch unit 255 may read IAB_5.

In step S451, the IAB search unit 253 searches for an index using a sort identifier ID_S at the read IAB. For example, the IAB search unit 253 may search for an index, including a sort identifier ID_S generated from the key, from among indexes of the read IAB.

Then in step S453, if it is determined whether a match occurs wherein an index associated with the key is found at the read IAB. If an index associated with the key is not found at the read IAB, it is determined in step S453 that there is no match.

If match does not occur at the read IAB, the IAB fetch unit 255 in step S455 reads a next IAB connected by a link L of the read IAB. For example, in the selected partition, in the case where IABs are written as illustrated in FIG. 16, the IAB fetch unit 255 may read IAB_4. Steps S451, S453 and S455 may be iteratively performed until match occurs at the selected partition.

Upon determination in step S453 that a match occurs at the selected partition, thereafter in step S460 the object processing circuit 220 outputs an object OBJ corresponding to the matched index to the host through the interface circuit 210 as a read response.

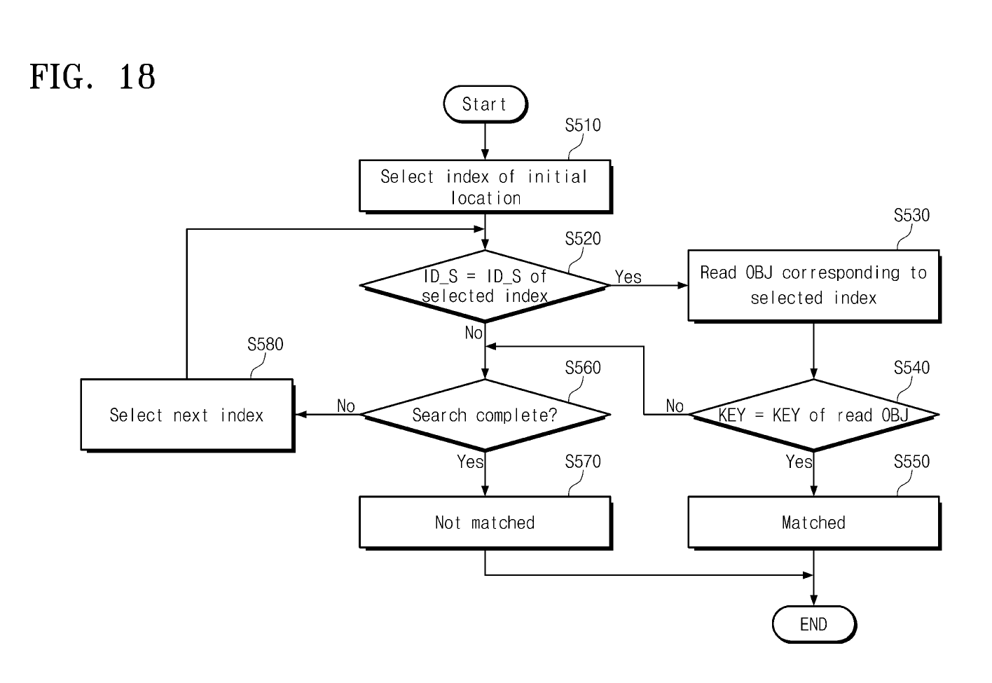

FIG. 18 illustrates a flow chart of a method in which an IAB search unit 253 determines a match. Referring to FIGS. 5 and 18, in step S510, the IAB search unit 253 selects an index of an initial location at an IAB read by the IAB fetch unit 255.

In step S520, the IAB search unit 253 determines whether a sort identifier ID_S of the selected index is the same as a sort identifier ID_S generated from a key. If the sort identifier ID_S of the selected index is not the same as the sort identifier ID_S generated from the key, process flow proceeds to step S560. However, if the sort identifier ID_S of the selected index is the same as the sort identifier ID_S generated from the key, in step S530 the OAB fetch unit 263 reads an object OBJ corresponding to the selected index from a selected partition.

In step S540, the IAB search unit 253 compares a key of the read object OBJ with the received key. If the key of the read object OBJ is the same as the received key, in step S550 match may be determined. If the key of the read object OBJ is different from the received key, the procedure proceeds to step S560.

In step S560, the IAB search unit 253 determines whether a search operation about the selected IAB is ended. For example, if a next index to be compared by the IAB search unit 253 does not exist, the search operation may be determined as being ended. Thereafter in step S570, the IAB search unit 253 determines that the match does not exist. If a next index to be compared by the IAB search unit 253 exists as determined in step S560, the search operation is determined as being not ended. Thereafter in step S580, the IAB search unit 253 selects a next index at the selected IAB, and the procedure returns to step S520.

As another example, when the sort identifier ID_S of the index selected in step S520 is the same as a sort identifier generated from the key, comparison may be additionally made using length information L_KEY of the key and length information L_OBJ of the object OBJ. For example, the IAB search unit 253 may compare a length of the received key with length information L_KEY of a key of the selected index. The IAB search unit 253 may compare a length of a requested object with length information L_OBJ of an object of the selected index. If the length of the key is the same as the length information L_KEY and the length of the object OBJ is the same as the length information L_OBJ, the OAB fetch unit 263 reads the object OBJ corresponding to the selected index in step S530. Even though the sort identifier ID_S generated from the key is the same as the sort identifier ID_S of the selected index, steps S530 to S560 may not be performed if the length of the key is not the same as the length information L_KEY or the length of the object OBJ is not the same as the length information L_OBJ.

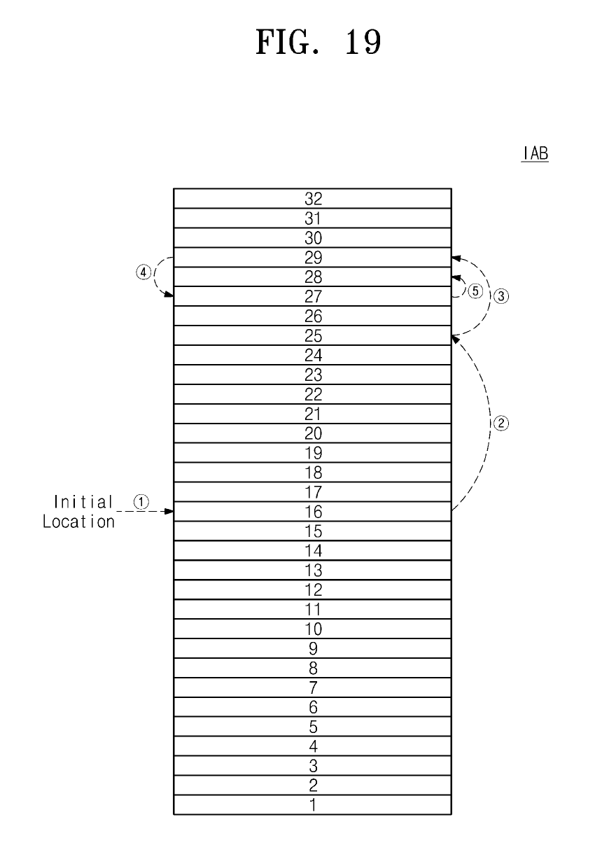

FIG. 19 illustrates an example in which a search operation is performed using a sort identifier ID_S. Referring to FIGS. 5, 18, and 19, one IAB is exemplified. Boxes which include reference numerals “1” to “32” respectively may represent indexes included in an IAB, respectively.

As described with reference to FIG. 14, indexes 1 to 32 of the IAB may be sorted or aligned based on a sort identifier ID_S. Accordingly, the IAB search unit 253 may perform a binary search using the sort identifier ID_S, thereby markedly reducing resources consumed to search for an index.

In an embodiment of the inventive concept, the initial location may be set at the middle of the indexes 1 to 32, whereby the location of the index 16 may be the initial location. As represented by a reference numeral \textcircled{1}, a sort identifier ID_S of the index 16 may be compared with a sort identifier ID_S generated from a key.

It may be assumed that the indexes 1 to 32 are sorted in a direction from the index 1 to the index 32, that is, in an ascending order of the sort identifiers ID_S. Furthermore, it may be assumed that a value of the sort identifier ID_S of the index 16 is smaller than a value of the sort identifier ID_S generated from the key. According to these assumptions, the probability that the indexes 1 to 15 each having the sort identifier ID_S of value smaller than that of the index 16 are the same as a sort identifier generated from a key may be considered nonexistent. Accordingly, the indexes 1 to 16 may be excluded from comparison.

An index which is located at the middle of indexes 17 to 32 may then be selected as a comparison target based on the binary search. For example, the index 25 may be selected as a comparison target. As represented by a reference numeral \textcircled{2}, a sort identifier ID_S of the index 25 may be compared with the sort identifier ID_S generated from the key.

Furthermore, it may be assumed that a value of the sort identifier ID_S of the index 25 is smaller than a value of the sort identifier ID_S generated from the key. In this case, the probability that the indexes 17 to 24 each having the sort identifier ID_S of value smaller than that of the index 25 are the same as a sort identifier generated from a key may be considered nonexistent. Accordingly, the indexes 17 to 25 may be excluded from comparison.

An index which is located at the middle of indexes 26 to 32 may then be selected as a comparison target based on the binary search. For example, the index 29 may be selected as a comparison target. As represented by a reference numeral \textcircled{3}, a sort identifier ID_S of the index 29 may be compared with the sort identifier ID_S generated from the key.

Furthermore, it may be assumed that a value of the sort identifier ID_S of the index 29 is larger than a value of the sort identifier ID_S generated from the key. In this case, the probability that the indexes 30 to 32 each having the sort identifier ID_S of value larger than that of the index 29 are the same as a sort identifier generated from a key may be considered nonexistent. Accordingly, the indexes 29 to 32 may be excluded from comparison.

An index which is located at the middle of indexes 26 to 28 may then be selected as a comparison target based on the binary search. For example, the index 27 may be selected as a comparison target. As represented by a reference numeral \textcircled{4}, a sort identifier ID_S of the index 27 may be compared with the sort identifier ID_S generated from the key.

In an embodiment, it may be assumed that a value of the sort identifier ID_S of the index 27 is smaller than a value of the sort identifier ID_S generated from the key. In this case, the probability that the index 26 having the sort identifier ID_S of value smaller than that of the index 27 is the same as a sort identifier generated from a key may be considered nonexistent. Accordingly, the indexes 26 to 27 may be excluded from comparison.

The last index 28 may be selected as a comparison target based on the binary search. As represented by a reference numeral \textcircled{5}, a sort identifier ID_S of the index 28 may be compared with the sort identifier ID_S generated from the key.

As a comparison target, a next index may not exist if the sort identifier ID_S of the index 28 is not the same as the sort identifier generated from the key. Accordingly, it may then be determined that no match occurs at an IAB, and a search operation may be performed at a next IAB.

If match occurs while searching an IAB, a search operation may be suspended, and a key of an object OBJ may be compared with the received key. If the key of the object OBJ is not the same as the received key, the suspended search operation may be resumed.

In general, a linear search approach may be used in which a key of a read object OBJ is compared with a received key in a one-to-one correspondence. If such a linear search is used, in the worst case, N times read operations and N times comparison operations may be performed in searching a partition in which N objects are stored.

A read frequency and a comparison frequency may be markedly reduced in the case where an IAB and a sort identifier ID_S according to an embodiment of the inventive concept are used and indexes corresponding to M objects are included in one IAB. For example, there is assumed the worst case that in performing the binary search, each of all comparison operations accompanies an object read operation, a search operation is performed at a plurality of IABs, and a match occurs at the last index. A read frequency may be summarized as illustrated in the following equation 1.

$$\frac{N}{M} \times ( 1 + {log}_{2} M ) \qquad [ Equation 1 ]$$

In an embodiment, N may be “163840” and M may be “16384”. According to the equation 1, a read frequency may be improved (reduced) about 1092 times compared with that when the linear search is used. An operating time taken to read the nonvolatile memory devices 290 may cause a decrease in life thereof. Accordingly, if the read frequency decreases, the operating speed of the storage device 140 may be improved, and the life of the storage device 140 may be extended.

A comparison frequency may be summarized as illustrated in the following equation 2.

$$2 \times \frac{N}{M} \times {log}_{2} M \qquad [ Equation 2 ]$$

According to the equation 2, a comparison frequency may be improved about 585 times compared with that when the linear search is used. The comparison frequency may necessitate an operating time of the object processing circuit 220. Accordingly, if the comparison frequency decreases, the operating speed of the storage device 140 may be improved.

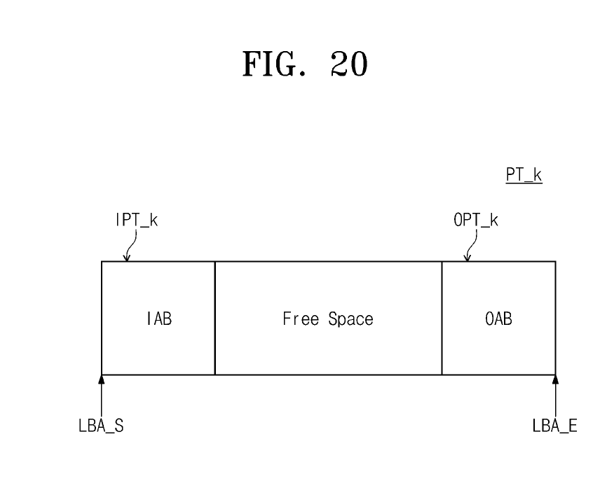

FIG. 20 illustrates an example in which an IAB and an OAB are written at a k-th partition PT_k. Referring to FIG. 20, an index partition IPT_k and an object partition OPT_k may be variable in size, not fixed. In an embodiment, the IAB may be sequentially written from a start logical address LBA_S of the k-th partition PT_k. An area where an IAB is written may be identified as an index partition IPT_k. The OAB may be sequentially written from the last logical address LBA_E of the k-th partition PT_k. An area where an OAB is written may be identified as an object partition IPT_k.

That is, the index partition IPT_k and the object partition OPT_k may be respectively grown from the start logical address LBA_S and the last logical address LBA_E of the k-th partition PT_k and may occupy a free space of the k-th partition PT_k. If the index partition IPT_k and the object partition OPT_k are configured as illustrated in FIG. 20, a storage space of the k-th partition PT_k may be prevented from being wasted in the case where it is impossible to write an object any longer because a free space exists at the index partition IPT_k but the index partition OTP_k is full, or in the case where it is impossible to write an object any longer because a free space exists at the object partition OPT_k but the index partition OTP_k is full.

In an embodiment, the size of IAB or the size of OAB may be adjusted according to characteristics of the storage device 140. For example, the size of IAB or the size of OAB may be adjusted according to a read unit or a write unit of the nonvolatile memory devices 290. For example, as a read unit or a write unit of the nonvolatile memory devices 290 becomes larger the size of IAB or the size of OAB may become larger, or as a read unit or a write unit of the nonvolatile memory devices 290 becomes smaller the size of IAB or the size of OAB may become smaller.

For example, the size of IAB or the size of OAB may be adjusted according to a capacity of the random access memory 280. For example, as a capacity of the random access memory 280 becomes greater the size of IAB or the size of OAB may become larger, or as a capacity of the random access memory 280 becomes smaller the size of IAB or the size of OAB may become smaller.

For example, the size of IAB or the size of OAB may be adjusted according to a capacity of an internal memory of the object processing circuit 220. For example, as a capacity of the IAB buffer 254 of the object processing circuit 220 or a capacity of the OAB buffer 261 thereof becomes larger the size of IAB or the size of OAB may become larger, or as a capacity of the IAB buffer 254 of the object processing circuit 220 or a capacity of the OAB buffer 261 thereof becomes smaller the size of IAB or the size of OAB may become smaller.

For example, the size of IAB or the size of OAB may be adjusted according to the frequency of a write request or a read request from an external host device. For example, as the frequency of a write request or a read request increases the size of IAB or the size of OAB may decreases, or as the frequency of a write request or a read request decreases the size of IAB or the size of OAB may decrease or increase.

In an embodiment, at least one of the request control part 230, the object managing part 240, the IAB manager 250, the identifier calculator 251, the partition unit 252, the IAB search unit 253, the IAB buffer 254, the IAB fetch unit 255, the IAB sort and flush unit 256, the OAB manager 260, the OAB buffer 261, the OAB fetch unit 263, and the OAB flush unit 265 of the object processing circuit 220 may be implemented with hardware. For example, the identifier calculator 251 may occupy about 30% of throughput of the object processing circuit 220. If a component, which occupies a lot of throughput such as the identifier calculator 251 is implemented with hardware, an operating speed of the object processing circuit 220 may be markedly improved.

An embodiment of the inventive concept is exemplified as each IAB has a link L indicating an IAB just previously written. However, in other embodiments each IAB may not have a link L. In an embodiment, each index partition IPT_k may have a given range of logical address LBA and each IAB may have a fixed size. Accordingly, a logical address LBA of a just previously written IAB may be calculated by moving a logical address LBA corresponding to a size of each IAB from a logical address LBA of an IAB being currently accessed.

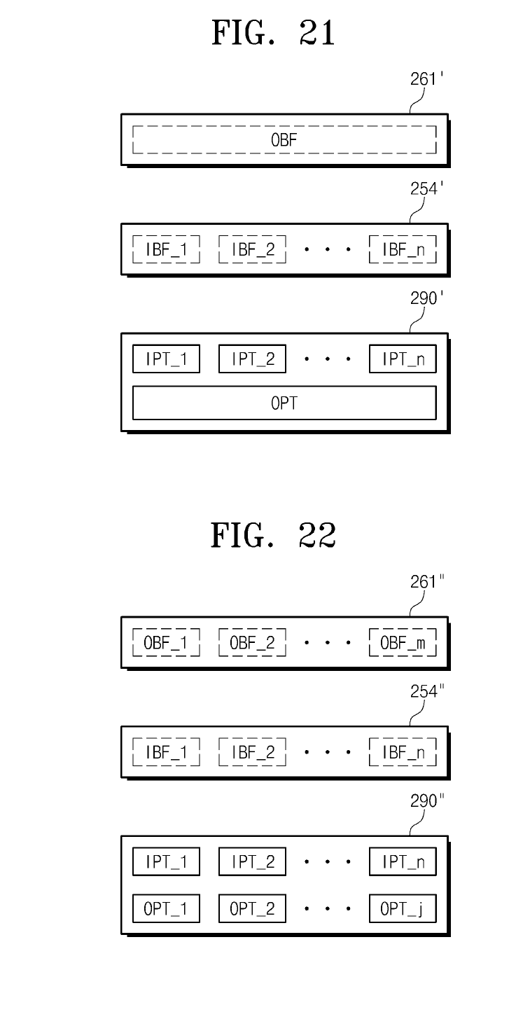

FIGS. 21 and 22 illustrates diagrams of examples in which an IAB buffer 254, an OAB buffer 261, and nonvolatile memory devices 290 are used. Referring to FIG. 21, an IAB buffer 254′ may be divided into a plurality of index buffers IBF_1 to IBF_n. The index buffers IBF_1 to IBF_n may correspond to index partitions IPT_1 to IPT_n of the nonvolatile memory devices 290′, respectively.

An OAB buffer 261′ may be used as an object buffer OBF. The object buffer OBF may correspond to an object partition OPT of nonvolatile memory devices 290′

In FIG. 21, the IAB may be read and written in the same method as described with reference to FIGS. 1 to 20. An OAB may be accumulated on one object buffer OBF without partition separation and may be written at one object partition OPT.

Referring to FIG. 22, an IAB buffer 254″ may be divided into a plurality of index buffers IBF_1 to IBF_n. The index buffers IBF_1 to IBF_n may correspond to index partitions IPT_1 to IPT_n of the nonvolatile memory devices 290″, respectively.

An OAB buffer 261″ may be divided into a plurality of object buffers OBF_1 to OBF_m. The object buffers OBF_1 to OBF_m may be configured regardless of the index buffers IBF_1 to IBF_n. Nonvolatile memory devices 290″ may include a plurality of index partitions IPT_1 to IPT_n and a plurality of object partitions OPT_1 to OPT_j. The object partitions OTP_1 to OPT_j may be configured regardless of the index partitions IPT_1 to IPT_n, the index buffers IBF_1 to IBF_n, or the object buffers OBF_1 to OBF_m.

In FIG. 22, the IAB may be read and written in the same method as described with reference to FIGS. 1 to 20. An OAB may be accumulated on the object buffers OBF_1 to OBF_m. The object buffers OBF_1 to OBF_m may correspond to write queues of cores which are respectively assigned to the OAB manager 260. The cores of the OAB manager 260 may enqueue OAB write requests in the write queues as objects are accumulated on the object buffers OBF_1 to OBF_m, respectively.

The number of object partitions OPT_1 to OPT_j may correspond to the number of threads which perform write requests in parallel. Write operations about the object partitions OPT_1 to OPT_j may be processed in parallel.

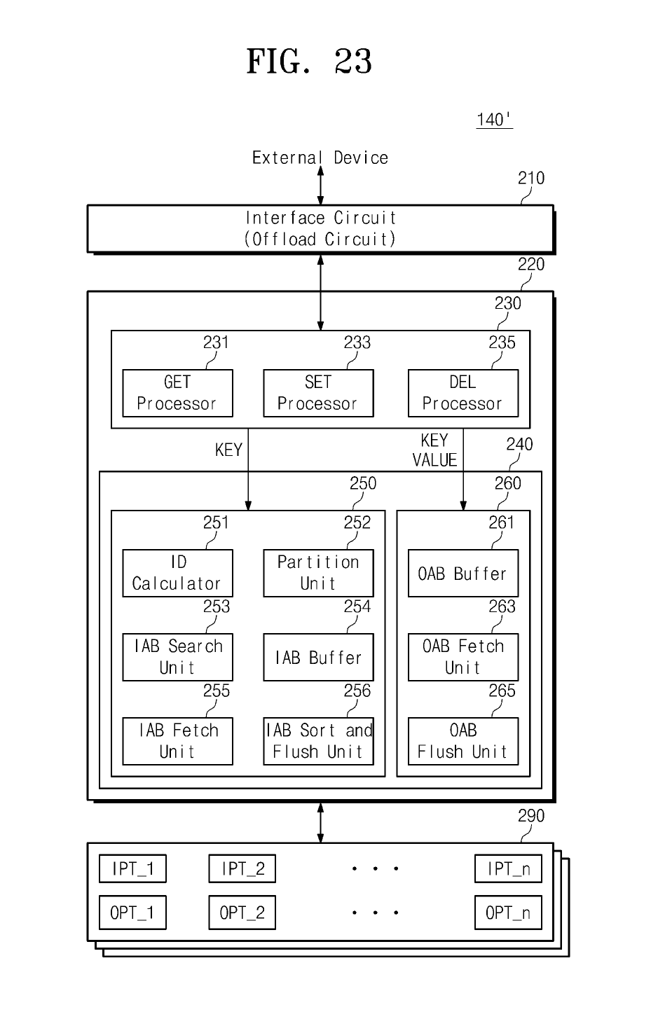

FIG. 23 illustrates a block diagram of a storage device 140′ according to an embodiment of the inventive concept. Compared with the storage device 140 of FIG. 5, the storage device 140′ of FIG. 23 does not include a control circuit and a random access memory.

The object processing circuit 220 in FIG. 23 is configured to generate a physical address PBA of the nonvolatile memory device 290, not a logical address LBA.

In an embodiment, the storage device 140′ may be used as storage of a server device. In this case, data written at the storage device 140′ may not be updated for a long time and may be used only for read operations. Accordingly, it may be possible to skip background operations for a flash memory device such as wear-leveling, garbage collection, and the like, and the object processing circuit 220 may directly access physical addresses of the nonvolatile memory device 290.

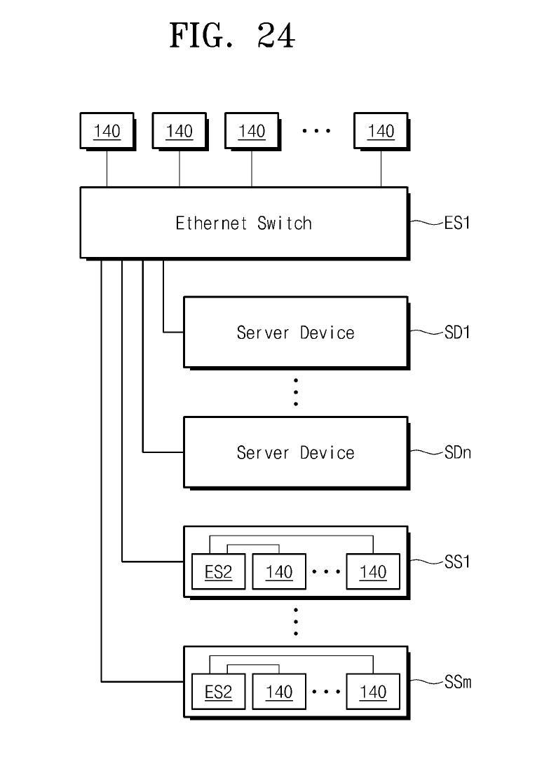

FIG. 24 illustrates a block diagram of a server system to which a storage device 140 or 140′ according to embodiments of the inventive concept is applied. Referring to FIG. 24, an Ethernet switch ES1 is connected with server devices SD1 to SDn. Each of the server devices SD1 to SDn may include application server devices, storage server devices, or cache server devices.

The Ethernet switch ES1 is directly connected with storage devices 140. The storage devices 140 may be used as storages of the server devices SD1 to SDn through the Ethernet switch ES1. For example, the storage devices 140 may be used as storage of application server devices.

The Ethernet switch ES1 is also connected with storage sets SS1 to SSm. Each of the storage sets SS1 to SSm includes a plurality of storage devices 140 and an internal Ethernet switch ES2. The storage devices 140 within the storage sets SS1 to SSm are connected to the respective internal Ethernet switches ES2. The internal Ethernet switches ES2 are connected with the Ethernet switch ES1. Each of the storage sets SS1 to SSm may be used as a storage server device.

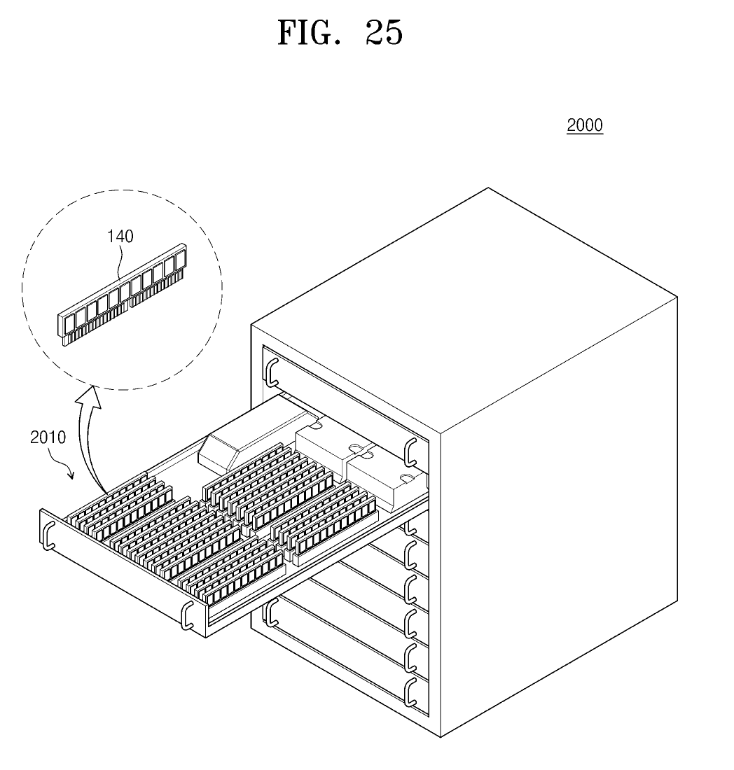

FIG. 25 illustrates a block diagram of a server device in which a storage device 140 or 140′ according to embodiments of the inventive concept is installed. Referring to FIG. 25, a server device 2000 includes two or more server racks 2010. Two or more storage devices 140 or 140′ are installed in each of the server racks 2010.

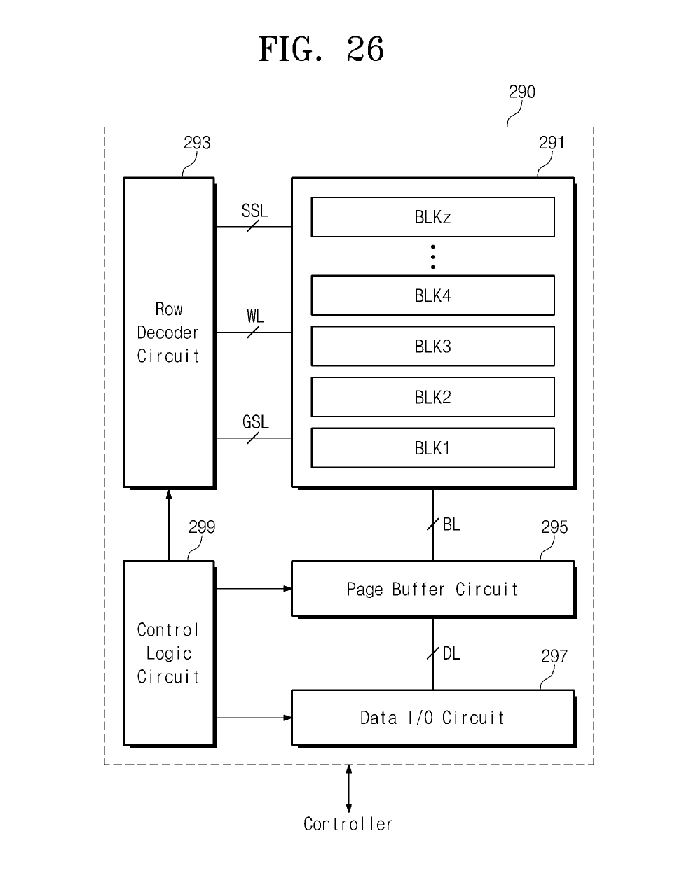

FIG. 26 illustrates a block diagram of a nonvolatile memory device 290 according to an embodiment of the inventive concept. Referring to FIGS. 5 and 26, the nonvolatile memory device 290 includes a memory cell array 291, a row decoder circuit 293, a page buffer circuit 295, a data input/output circuit 297, and a control logic circuit 299.

The memory cell array 291 includes a plurality of memory cells BLK1 to BLKz each including a plurality of memory cells. Each memory block may be connected to the row decoder circuit 293 through at least one string selection line SSL, a plurality of word lines WL, and at least one ground selection line GSL. Each memory block may be connected to the page buffer circuit 295 through a plurality of bit lines BL. The memory blocks BLK1 through BLKz may be connected in common to the plurality of bit lines BL. Memory cells in the memory blocks BLK1 through BLKz may have the same structure.

In an embodiment, each of the memory blocks BLK1 through BLKz may be a unit of an erase operation. An erase operation may be carried out by the memory block. Memory cells in a memory block may be erased at the same time. In other embodiments, each memory block may be divided into a plurality of sub-blocks and erasing may be made by the sub-block.

In an embodiment, each of the memory blocks BLK1 to BLKz may include a physical storage space which is distinguished by a block address. Each of the word lines WL may correspond to a physical storage space which is distinguished by a row address. Each of the bit lines BL may correspond to a physical storage space which is distinguished by a column address.

The row decoder circuit 293 may be connected to the memory cell array 291 through a plurality of ground selection lines GSL, the plurality of word lines WL, and a plurality of string selection lines SSL. The row decoder circuit 293 may operate according to control of the control logic circuit 299. The row decoder circuit 293 may decode an address received from the control circuit 270 through an input/output channel and may control voltages to be applied to the string selection lines SSL, the word lines WL, and the ground selection lines GSL based on the decoded address.

For example, at programming, the row decoder circuit 293 may apply a program voltage to a selected word line in a memory block selected by an address, and a pass voltage to unselected word lines in the selected memory block. At reading, the row decoder circuit 293 may apply a selection read voltage to the selected word line in the selected memory block, and a non-selection read voltage to unselected word lines in the selected memory block. At erasing, the row decoder circuit 293 may apply an erase voltage (e.g., a ground voltage or a low voltage of which the level is similar to that of the ground voltage) to word lines in the selected memory block.

The page buffer 295 may be connected to the memory cell array 291 through the bit lines BL. The page buffer circuit 295 may operate under control of the control logic circuit 299.

During programming, the page buffer circuit 295 may store data to be programmed in memory cells. The page buffer circuit 295 may apply voltages to the bit lines BL based on the stored data. The page buffer circuit 295 may function as a write driver. During reading, the page buffer circuit 295 may sense voltages on the bit lines BL and may store the sensed results. The page buffer circuit 295 may function as a sense amplifier.

The data input/output circuit 297 may be connected to the page buffer circuit 295 through the data lines DL. The data input/output circuit 297 may output data, which is read by the page buffer circuit 295, to the control circuit 270 (Controller) through the input/output channel and may transfer data, which is received from the control circuit 270 through the input/output channel, to the page buffer circuit 295.

The control logic circuit 299 may receive a command from the control circuit 270 through the input/output channel and may receive a control signal therefrom through a control channel. The control logic circuit 299 may receive a command, which is received through the input/output channel, in response to the control signal, may route an address, which is received through the input/output channel, to the row decoder circuit 293, and may route data, which is received through the input/output channel, to the data input/output circuit 297. The control logic circuit 299 may decode the received command and may control the nonvolatile memory device 290 based on the decoded command.

In an embodiment, the control logic circuit 299 may generate a data strobe signal DQS based on a read enable signal/RE received from the control circuit 270 through the input/output channel. The data strobe signal DQS thus generated may be outputted to the control circuit 270 through the control channel. At writing, the control logic circuit 299 may receive the data strobe signal DQS from the control circuit 270 through the control channel.

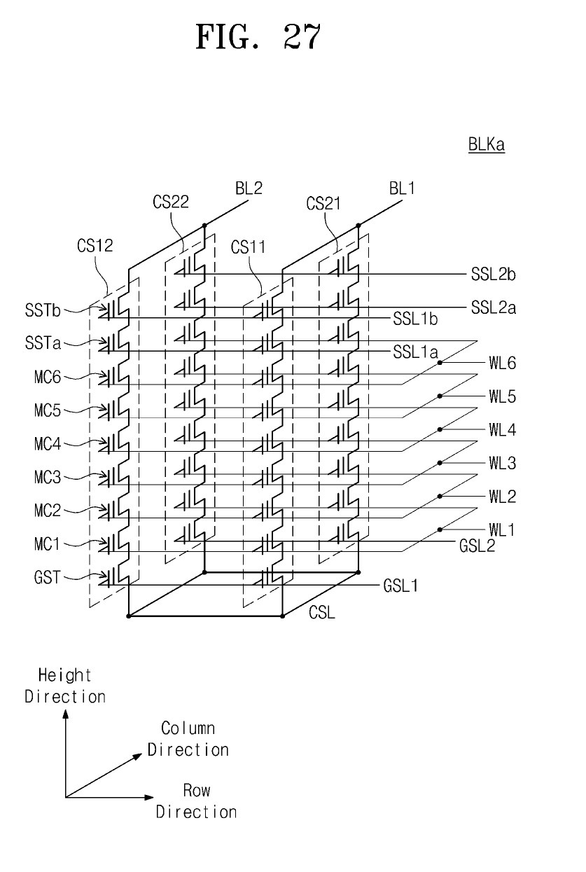

FIG. 27 is a circuit diagram illustrating a memory block BLKa according to an embodiment of the inventive concept. Referring to FIG. 27, a memory block BLKa may include a plurality of cell strings CS11 to CS21 and CS12 to CS22. The plurality of cell strings CS11 to CS21 and CS12 to CS22 may be arranged in a matrix of rows and columns.

For example, the cell strings CS11 and CS12 arranged along a row direction may constitute a first row, and the cell strings CS21 and CS22 arranged along the row direction may constitute a second row. The cell strings CS11 and CS21 arranged along a column direction may constitute a first column, and the cell strings CS12 and CS22 arranged along the column direction may constitute a second column.

Each cell string may contain a plurality of cell transistors. The cell transistors may include ground selection transistors GST, memory cells MC1 through MC6, and string selection transistors SSTa and SSTb. The ground selection transistors GST, memory cells MC1 through MC6, and string selection transistors SSTa and SSTb in each cell string may be stacked in a height direction perpendicular to a plane (e.g., a plane on a substrate of the memory block BLKa) on which the cell strings CS11 to CS21 and CS12 to CS22 are arranged along the rows and the columns.

Each cell transistor may be a charge trap type cell transistor of which the threshold voltage changes according to the amount of charges trapped in an insulating layer thereof.

Lowermost ground selection transistors GST may be connected in common to a common source line CSL.

Control gates of ground selection transistors GST of the cell strings CS11 and CS12 in a first row may be connected in common to a ground selection line GSL1, and control gates of ground selection transistors GST of the cell strings CS21 and CS22 in a second row may be connected in common to a ground selection line GSL2. That is, cell strings in different rows may be connected to different ground selection lines.

In an embodiment, the memory block BLKa may be modified or changed such that ground selection lines which are connected to ground selection transistors belonging to the same row and placed at different heights are connected to different ground selection lines. In an embodiment, the memory block BLKa may be modified or changed such that ground selection lines which are connected to ground selection transistors belonging to different rows and placed at the same height are interconnected and controlled in common. In an embodiment, the memory block BLKa may be modified or changed such that ground selection lines which are connected to ground selection transistors are interconnected and controlled in common.

Connected in common to a word line are control gates of memory cells that are placed at the same height (or order) from the substrate (or the ground selection transistors GST). Connected to different word lines WL1 to WL6 are control gates of memory cells that are placed at different heights (or, orders). For example, the memory cells MC1 may be connected in common to the word line WL1. Memory cells MC2 may be commonly connected to a word line WL2. The memory cells MC3 may be connected in common to the word line WL3. The memory cells MC4 may be connected in common to the word line WL4. The memory cells MC5 may be connected in common to the word line WL5. The memory cells MC6 may be connected in common to the word line WL6.

In first string selection transistors SSTa, having the same height (or, order), of the cell strings CS11 to CS21 and CS12 to CS22, control gates of the first string selection transistors SSTa in different rows may be connected to different string selection lines SSL1a and SSL2a, respectively. For example, the first string selection transistors SSTa of the cell strings CS11 and CS12 may be connected in common to the string selection line SSL1a. The first string selection transistors SSTa of the cell strings CS21 and CS22 may be connected in common to the string selection line SSL2a.

In second string selection transistors SSTb, having the same height (or, order), of the cell strings CS11 to CS21 and CS12 to CS22, control gates of the second string selection transistors SSTb in different rows may be connected to the different string selection lines SSL1a and SSL2a. For example, the second string selection transistors SSTb of the cell strings CS11 and CS12 may be connected in common to the string selection line SSL1b. The second string selection transistors SSTb of the cell strings CS21 and CS22 may be connected in common to the string selection line SSL2b.

That is, cell strings in different rows may be connected to different string selection lines. String selection transistors, having the same height (or, order), of cell strings in the same row may be connected to the same string selection line. String selection transistors, having different heights (or, orders), of cell strings in the same row may be connected to different string selection lines.

In exemplary embodiments, string selection transistors of cell strings in the same row may be connected in common to a string selection line. For example, the string selection transistors SSTa and SSTb of the cell strings CS11 and CS12 in a first row may be connected in common to a string selection line. The string selection transistors SSTa and SSTb of the cell strings CS21 and CS22 in a second row may be connected in common to a string selection line.

Columns of the cell strings CS11 through CS21 and CS12 through CS22 may be connected to different bit lines BL1 and BL2, respectively. For example, the string selection transistors SSTb of the cell strings CS11 and CS21 may be connected in common to the bit line BL1. The string selection transistors SSTb of the cell strings CS12 and CS22 may be connected in common to the bit line BL2.

The cell strings CS11 and CS12 may constitute a first plane. The cell strings CS21 and CS22 may constitute a second plane.

In the memory block BLKa, memory cells of each plane placed at the same height may compose a physical page. A physical page may be a unit of writing and reading the memory cells MC1 to MC6. One plane of the memory block BLKa may be selected by the string selection lines SSL1a, SSL1b, SSL2a, and SSL2b. The cell strings CS11 and CS12 in a first plane may be connected to the bit lines BL1 and BL2 when a turn-on voltage is supplied to the string selection lines SSL1a and SSL1b and a turn-off voltage is supplied to the string selection lines SSL2a and SSL2b. That is, the first plane may be selected. The cell strings CS21 and CS22 in a second plane may be connected to the bit lines BL1 and BL2 when the turn-on voltage is supplied to the string selection lines SSL2a and SSL2b and the turn-off voltage is supplied to the string selection lines SSL1a and SSL1b. That is, the second plane may be selected. In a selected plane, a row of memory cells MC may be selected by the word lines WL1 to WL6. In the selected row, a selection voltage may be applied to the second word line WL2, and a non-selection voltage may be applied to the remaining word lines WL1 and WL3 to WL6. That is, a physical page which corresponds to the second word line WL2 of the second plane may be selected by adjusting voltages on the string selection lines SSL1a, SSL1b, SSL2a, and SSL2b and the word lines WL1 to WL6. A write or read operation may be performed with respect to memory cells MC2 in the selected physical page.

For example, two or more bits may be written at each memory cell MC. Bits which are written at memory cells belonging to one physical page may form logical pages. First bits which are written at memory cells belonging to one physical page may form a first logical page. N-th bits which are written at memory cells belonging to one physical page may form an N-th logical page. A logical page may refer to a data access unit. Data may be accessed by the logical page when a read operation is performed with respect to one physical page.

In the memory block BLKa, the memory cells MC1 to MC6 may be erased by the memory block or by the sub-block. When erasing is performed by the memory block, all memory cells MC in the memory block BLKa may be simultaneously erased according to an erase request (e.g., an erase request from an external controller). When erasing is performed by the sub-block, a portion of memory cells MC in the memory block BLKa may be simultaneously erased according to an erase request (e.g., an erase request from an external controller), and the other thereof may be erase-inhibited. A low voltage (e.g., a ground voltage or a low voltage of which the level is similar to that of the ground voltage) may be supplied to a word line connected to erased memory cells MC, and a word line connected to erase-inhibited memory cells MC may be floated.

The memory block BLKa shown in FIG. 27 is an example. However, in other embodiments, the number of rows of cell strings may increase or decrease, and correspondingly the number of string or ground selection lines and the number of cell strings connected to a bit line may also be changed. The number of columns of cell strings may increase or decrease, and correspondingly the number of bit lines connected to columns of cell strings and the number of cell strings connected to a string selection line may also be changed. A height of the cell strings may increase or decrease, and correspondingly the number of ground selection transistors, memory cells, or string selection transistors that are stacked in each cell string may increase or decrease.

In exemplary embodiments, memory cells MC in a physical page may correspond to at least three logical pages. For example, k bits (k being an integer of 2 or more) may be programmed in a memory cell MC. In memory cells MC of one physical page, k logical pages may be implemented with k bits programmed in each memory cell MC.

In an embodiment of the inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the inventive concept, the 3D memory array includes vertical NAND strings that are vertically oriented such that at least one memory cell is located over another memory cell. The at least one memory cell may comprise a charge trap layer. Each vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

According to an embodiment of the inventive concept, there may be provided a storage device, which supports a function of a server device, and an operating method of the storage device. Accordingly, a load of the server device may be reduced, and expandability about the server device may be improved. The resources and capacity of a server device may be expanded by only adding cost associated with adding storage devices, thereby making it possible to manage more content with less cost than when further server devices are instead added. Furthermore, an operating speed of the storage device may be improved. Accordingly, an operating speed of a server device including the storage device may be improved.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

1. A storage device comprising:
an interface circuit configured to communicate with an external device;
nonvolatile memory devices forming a plurality of partitions; and
a processing circuit configured to receive a write request, a key, and a value from the interface circuit, to generate a partition identifier and a sort identifier from the received key, to select one of the partitions using the partition identifier, and to sort indexes of accumulated keys corresponding to the selected partition using sort identifiers included in the indexes.

2. The storage device of claim 1, wherein the processing circuit is configured to sort the indexes and to write the sorted indexes at the selected partition as an index block upon determination that an accumulated size of the indexes reaches a reference size.

3. The storage device of claim 2, wherein the index block comprises a link indicating a start address of an index block most recently written at the selected partition or a start address of an area of the selected partition where the index block is to be written.

4. The storage device of claim 1, wherein each of the indexes comprises a separate sort identifier generated from a separate key, and a separate address, and
wherein the separate address indicates a location of the selected partition where the separate key and a separate value corresponding to the separate key are written.

5. The method of claim 4, wherein each of the indexes further comprises first length information of the separate key, and second length information of the separate key and the separate value.

6. The storage device of claim 1, wherein the processing circuit is configured to generate an address of a location where the received key and the received value are to be written, in response to the write request.

7. The storage device of claim 6, wherein the address is a logical address, the storage device further comprising:
a control circuit configured to convert the logical address into a physical address of the nonvolatile memory devices.

8. The storage device of claim 1, wherein the processing circuit is configured to store an address of an index block most recently written at each partition.

9. The storage device of claim 1, wherein the processing circuit is configured to write the accumulated keys and accumulated values at the nonvolatile memory devices as an object block upon determination that a size of the accumulated keys and the accumulated values reaches a reference size.

10. The storage device of claim 9, wherein sizes of the accumulated values are different from each other.

11. The storage device of claim 1, wherein the processing circuit is configured to receive a read request and a second key from the interface circuit, to generate a second partition identifier and a second sort identifier from the received key, to select a second partition of the partitions using the second partition identifier, and to search for second indexes stored in the second partition using the second sort identifier.

12. The storage device of claim 11, wherein the processing circuit is configured to search for an index comprising the second sort identifier from among sort identifiers of the second indexes stored in the selected second partition.

13. The storage device of claim 11, wherein the processing circuit is configured to search for an index comprising the second sort identifier from among the second indexes sorted by sort identifiers through a binary search.

14. The storage device of claim 11, wherein the processing circuit is configured to search for third indexes stored in the selected second partition upon determination that an index comprising the second sort identifier is not found among the second indexes.

15. The storage device of claim 14, wherein the second indexes comprise a link indicating a location of the selected second partition where the third indexes are stored.

16. The storage device of claim 11, wherein upon finding among the second indexes an index comprising the second sort identifier, the processing circuit is configured to compare at least one of first length information of a key included in the found index, or second length information of a key and a value included in the found index, with information included in the read request.

17. The storage device of claim 11, wherein upon finding among the second indexes an index comprising the second sort identifier, the processing circuit is configured to read a key and a value from the nonvolatile memory devices using an address included in the found index.

18. The storage device of claim 17, wherein the processing circuit is configured to output the read key and the read value through the interface circuit upon determination that the read key is the same as the second key, and to ignore the found index and continue to search upon determination that the read key is not the same as the second key.

19. A storage device comprising:
an interface circuit configured to communicate with an external device;
nonvolatile memory devices forming a plurality of partitions; and
a processing circuit configured to receive a read request and a key from the interface circuit, to generate a partition identifier and a sort identifier from the received key, to select one of the partitions using the partition identifier, and to search for indexes stored in the selected partition using the sort identifier.

20. An operating method of a storage device which comprises a nonvolatile memory device, the operating method comprising:
receiving at the storage device a plurality of keys and values respectively corresponding to the keys;
generating at the storage device a plurality of indexes including a plurality of sort identifiers respectively corresponding to the keys;
sorting at the storage device the indexes by a unit of a first block size based on the sort identifiers and storing the sorted indexes in the nonvolatile memory device;
storing the keys and the values in the nonvolatile memory device by a unit of a second block size; and
upon determining at the storage device that a value corresponding to a specific key is requested, searching for the indexes using a sort identifier corresponding to the specific key by a unit of the first block size.

21-22. (canceled)
